(19) United States
(12) Patent Application Publication
(10) Pub. No.: US 2024/0140143 A1
(43) Pub. Date: May 2, 2024

(54) PNEUMATIC TIRE

(71) Applicants: The Yokohama Rubber Co., LTD., Kanagawa (JP); SHANDONG XINGDA TYRE CO. LTD., Dongying, Shandong (CN)

(72) Inventors: Hiroaki HONDA, Kanagawa (JP); Mingquan WANG, Dongying, Shandong (CN); Feng GAO, Dongying, Shandong (CN); Guangliang WAN, Dongying, Shandong (CN); Youjun LIU, Dongying, Shandong (CN)

(21) Appl. No.: 18/548,177

(22) PCT Filed: Mar. 2, 2021
(86) PCT No.: PCT/CN2021/078720

§ 371 Date: Aug. 28, 2023

(51) Int. Cl. B60C 15/024; B60C 15/00

(52) U.S. Cl. CPC B60C 15/024; B60C 15/0009

(57) ABSTRACT

A pneumatic tire includes: bead cores formed by winding bead wires in a ring shape and having a polygonal cross-section shape in a meridian cross-section; a carcass extended between bead portions on both sides in a width direction, the carcass being folded back to an outer side in the width direction of the bead portion, the carcass being formed by coating a carcass cord with a coating rubber; an inner organic fiber reinforced layer wound around the bead core and formed by coating an organic fiber cord with a coating rubber; and a rubber reinforcing layer between the inner organic fiber reinforced layer and the carcass to cover at least an apex on an innermost side of the bead core in the width direction. A shortest distance between the bead wire and the carcass cord is 3 mm or more.

### TECHNICAL FIELD

The present technology relates to a pneumatic tire.

### BACKGROUND ART

A pneumatic tire is mounted on a rim wheel by fitting, to a rim of a rim wheel, a bead portion with a bead core corresponding to an annular member including a plurality of bead wires bundled. The bead portion is a portion that is actually mounted on the rim wheel in a case where the pneumatic tire is mounted on the rim wheel and thus is an important portion for durability and ensuring performance of the pneumatic tire. In some known pneumatic tires, various devices are made to the bead portions to achieve desired performance.

For example, in the pneumatic tire described in Japan Patent No. 5981136 B, a rubber sheet layer that continuously covers from a lower portion of a belt layer to an inner surface side of a bead filler through below a bead portion is provided. A rubber hardness of the rubber sheet layer is differentiated according to a region to reduce road noise. Further, in the heavy duty pneumatic tire described in Japan Patent No. 4934178 B, a surface of a bead core substrate is surrounded by a wrapping material in which a plurality of organic fiber cords are coated with a topping rubber, and the shortest distance between a steel wire on an innermost side of the bead core substrate in a tire axial direction and a carcass cord is set to 1.8 to 3.0 mm, thereby suppressing break of the carcass cord and improving durability of a bead portion. Further, the pneumatic tire described in Japan Patent No. 5878534 B has two organic fiber reinforced layers spirally wound around bead cores, an organic fiber cord of an organic fiber reinforced layer on an inner layer side is wound with a gap at least partially in a tire circumferential direction without overlap in the tire circumferential direction, and an organic fiber reinforced layer on an outer layer side is provided to cover at least a portion of a gap of the organic fiber reinforced layer on the inner layer side, thereby preventing a decrease in durability of a carcass ply.

In the pneumatic tire described in Japan Patent No. 4878179 B, a bead core includes a core body and a wrapping rubber layer, and a lower apex portion made from hard rubber has an L-shaped cross-section having a bottom piece portion along an upper surface of the bead core in a tire radial direction and a rising piece portion rising from an inner end of the bottom piece portion in a tire axial direction and extending outward in the tire radial direction. A rubber hardness of the wrapping rubber layer and a rubber hardness of the lower apex portion range from 82 to 87°, and thus rolling resistance performance is improved while head durability is highly ensured. Further, in the pneumatic radial tire described in Japan Patent No. 4996112 B, three bead cover tapes formed by rubber-coating a plain weave fabric made from organic fiber are wound around outer circumferential surfaces of bead cores in an overlapping manner, and an overlapping portion of the three bead cover tapes is present on one specific surface of the bead core, thereby preventing the bead core from losing its shape during vulcanization molding.

In recent years, vehicles used in mines have been required to increase in size for the purpose of improving transportation efficiency, and pneumatic tires mounted on such vehicles have also been required to be ultra-large pneumatic tires that can withstand an increased load capacity and have a further high load capacity. In an ultra-large pneumatic tire, a bead core generally has a polygonal shape in a tire meridian cross-section. To avoid stress concentration on a carcass by a corner of the head core, some ultra-large pneumatic tires include a nylon cover wound around the bead cores. However, with only the nylon cover, a distance between the corner of the bead core and the carcass is not sufficient. Therefore, when a large tensile force acts on the carcass, the vicinity of the corner of the bead core and the carcass rub against one another while receiving a large force, and thus the bead core is possibly exposed from the nylon cover. In this case, the corner of the bead core and the carcass rub against one another, and the carcass cord is possibly broken. Therefore, in the conventional pneumatic tire, there is room for improvement in terms of the durability of the bead portion.

### SUMMARY

The present technology provides a pneumatic tire that can provide improved durability of a head portion.

A pneumatic tire according to the present technology may include a pair of bead portions, bead cores, a carcass, an inner organic fiber reinforced layer, and a rubber reinforcing layer. The pair of bead portions may be disposed on both sides of a tire equatorial plane in a tire width direction. The bead cores may be disposed in the bead portions. The bead cores may be formed by winding bead wires in a ring shape and have a shape in a tire meridian cross-section formed in a polygonal cross-section. The carcass may be extended between the bead portions on both of the sides in the tire width direction. The carcass may run through an inner side of the bead core in a tire radial direction from an inner side of the bead core in the tire width direction and be folded back to an outer side in the tire width direction in the bead portion. The carcass may be formed by coating a carcass cord with a coating rubber. The inner organic fiber reinforced layer may be wound around the bead core and formed by coating an organic fiber cord with a coating rubber. The rubber reinforcing layer may be disposed between the inner organic fiber reinforced layer and the carcass so as to cover at least an apex on an innermost side of the bead core in the tire width direction. A shortest distance between the bead wire and the carcass cord may be 3 mm or more.

Further, in the pneumatic tire, the rubber reinforcing layer is preferably disposed to run through the inner side of the bead core in the tire radial direction from the inner side of the bead core in the tire width direction to an outer side of the bead core in the tire width direction. A rubber adhesive layer is preferably disposed between the rubber reinforcing layer and the carcass to run through the inner side of the bead core in the tire radial direction from the inner side of the bead core in the tire width direction to the outer side of the bead core in the tire width direction. The rubber adhesive layer preferably has a rubber hardness equal to or more than a rubber hardness of the coating rubber of the carcass. The rubber reinforcing layer preferably has a rubber hardness harder than a rubber hardness of the rubber adhesive layer and a rubber hardness of the coating rubber of the inner organic fiber reinforced layer. The rubber adhesive layer preferably has a sulfur content equal to or more than a sulfur content of the coating rubber of the carcass.

Further, in the pneumatic tire, the rubber adhesive layer preferably has a rubber hardness in a range of 72 or more and 78 or less.

Further, in the pneumatic tire, in portions located on the inner side of the bead core in the tire width direction of the rubber adhesive layer and the rubber reinforcing layer, an end portion on an outer side of the rubber adhesive layer in the tire radial direction is preferably located further on the outer side in the tire radial direction than an end portion on the outer side of the rubber reinforcing layer in the tire radial direction.

Further, in the pneumatic tire, the rubber reinforcing layer preferably has an end portion on an outer side in the tire radial direction located further on the outer side in the tire radial direction than an outer circumferential surface of the bead core.

Further, in the pneumatic tire, the rubber adhesive layer preferably contains a cobalt compound.

Further, the pneumatic tire preferably includes an outer organic fiber reinforced layer formed by coating an organic fiber cord with a coating rubber. The outer organic fiber reinforced layer is preferably disposed at least between the rubber reinforcing layer and the carcass. The outer organic fiber reinforced layer is preferably disposed to run through the inner side of the bead core in the tire radial direction from the inner side of the bead core in the tire width direction to an outer side of the bead core in the tire width direction.

Further, in the pneumatic tire, the rubber reinforcing layer preferably has a rubber hardness equal to or more than rubber hardnesses of the coating rubber of the inner organic fiber reinforced layer and the coating rubber of the outer organic fiber reinforced layer.

Further, in the pneumatic tire, the organic fiber cord of the outer organic fiber reinforced layer preferably has a thickness equal to or more than a thickness of the organic fiber cord of the inner organic fiber reinforced layer.

Further, in the pneumatic tire, the coating rubber of the outer organic fiber reinforced layer preferably has a rubber hardness equal to or more than a rubber hardness of the coating rubber of the inner organic fiber reinforced layer.

Further, in the pneumatic tire, the outer organic fiber reinforced layer is preferably formed by spirally winding a band-like member around the bead core extending in a tire circumferential direction. The band-like member is preferably spirally wound while adjacent circumferential portions are in contact with one another.

Further, in the pneumatic tire, the inner organic fiber reinforced layer is preferably formed by spirally winding a band-like member around the bead core extending in a tire circumferential direction. In the inner organic fiber reinforced layer and the outer organic fiber reinforced layer, a direction in which the band-like member forming the inner organic fiber reinforced layer is spirally wound is preferably same as a direction in which the band-like member forming the outer organic fiber reinforced layer is spirally wound.

Further, in the pneumatic tire, the shortest distance between the bead wire and the carcass cord is preferably in a range of 4 mm or more and 8 mm or less.

Further, in the pneumatic tire, the rubber reinforcing layer preferably has a rubber hardness in a range of 80 or more and 85 or less.

Further, in the pneumatic tire, a bead filler is preferably disposed on the inner side of a turned-up portion in the tire width direction and an outer side of the bead core in the tire radial direction. The turned-up portion is preferably a portion folded back to the outer side of the head core in the tire width direction in the carcass. The rubber reinforcing layer preferably has a rubber hardness equal to or more than a rubber hardness of the bead filler.

The pneumatic tire according to an embodiment of the present technology has an effect of allowing providing improved durability of the head portion.

### BRIEF DESCRIPTION OF DRAWINGS

FIG. 1 is a meridian cross-sectional view illustrating a main portion of a pneumatic tire according to a first embodiment.

FIG. 2 is a detailed view of portion A of FIG. 1.

FIG. 3 is an explanatory diagram illustrating a state in which an inner organic fiber reinforced layer illustrated in FIG. 2 is wound around a bead core.

FIG. 4 is a detailed view of portion B of FIG. 2.

FIG. 5 is a meridian cross-sectional view illustrating a main portion of a pneumatic tire according to a second embodiment.

FIG. 6 is a detailed view of portion C of FIG. 5.

FIG. 7 is an explanatory diagram illustrating a state in which an inner organic fiber reinforced layer, a rubber reinforcing layer, and an outer organic fiber reinforced layer illustrated in FIG. 6 are wound around a bead core.

FIG. 8 is a detailed view of portion D of FIG. 6.

FIG. 9 is a modified example of the pneumatic tire according to the first embodiment, and is an explanatory diagram of a state in which an outer end portion of the rubber reinforcing layer in an outer side in a tire width direction is located further on an inner side in a tire radial direction than an outer circumferential surface of the bead core.

FIG. 10 is the modified example of the pneumatic tire according to the first embodiment, and is an explanatory diagram of a state in which the outer end portion of the rubber reinforcing layer in an inner side in the tire width direction is located further on an inner side in the tire radial direction than the outer circumferential surface of the bead core.

FIG. 11 is the modified example of the pneumatic tire according to the first embodiment, and is an explanatory diagram of a state in which the outer end portions of the rubber reinforcing layer on both sides in the tire width direction are located further on the inner side in the tire radial direction than the outer circumferential surface of the bead core.

FIG. 12 is the modified example of the pneumatic tire according to the first embodiment, and is an explanatory diagram in a case in which the cross-sectional shape of the bead core is formed of an octagon.

FIG. 13 is a modified example of the pneumatic tire according to a second embodiment, and is an explanatory diagram of a state in which the rubber reinforcing layer is disposed from the inner side of the bead core in the tire width direction to the outer side in the tire width direction.

FIG. 14 is the modified example of the pneumatic tire according to the second embodiment, and is an explanatory diagram of a state in which the rubber reinforcing layer is disposed on the inner side of the bead core in the tire width direction.

FIG. 15 is the modified example of the pneumatic tire according to the second embodiment, and is an explanatory diagram of a state in which the outer organic fiber reinforced layer is disposed from the inner side of the bead core in the tire width direction to the outer side in the tire width direction.

FIG. 16 is the modified example of the pneumatic tire according to the second embodiment, and is an explanatory diagram in a case in which the cross-sectional shape of the bead core is formed of an octagon.

FIG. 17 is the modified example of the pneumatic tire according to the first embodiment, and is an explanatory diagram in a case where a plurality of the bead cores are disposed in a bead portion.

FIG. 18 is the modified example of the pneumatic tire according to the second embodiment, and is an explanatory diagram in a case where a plurality of the bead cores are disposed in a bead portion.

FIGS. 19A-19D include a table indicating results of a first performance evaluation test of pneumatic tires.

FIGS. 20A-20D include a table indicating results of a second performance evaluation test of pneumatic tires.

### DETAILED DESCRIPTION

Pneumatic tires according to embodiments of the present technology are described in detail below with reference to the drawings. However, the technology is not limited to the embodiment. Constituents of the following embodiments include elements that can be substituted and easily conceived of by a person skilled in the art or that are essentially identical.

### First Embodiment

In the following description, the term “tire radial direction” refers to a direction orthogonal to the tire rotation axis (not illustrated) which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction. The term “tire circumferential direction” refers to a circumferential direction with the tire rotation axis as a center axis, Additionally, the term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane: that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The tire width is the width in the tire width direction between portions located on the outermost sides in the tire width direction, or in other words, the distance between the portions that are the most distant from the tire equatorial plane CL in the tire width direction. “Tire equator line” refers to a line in the tire circumferential direction of the pneumatic tire 1 that lies on the tire equatorial plane CL. In the description below, “tire meridian section” refers to a cross-section of the tire taken along a plane that includes the tire rotation axis.

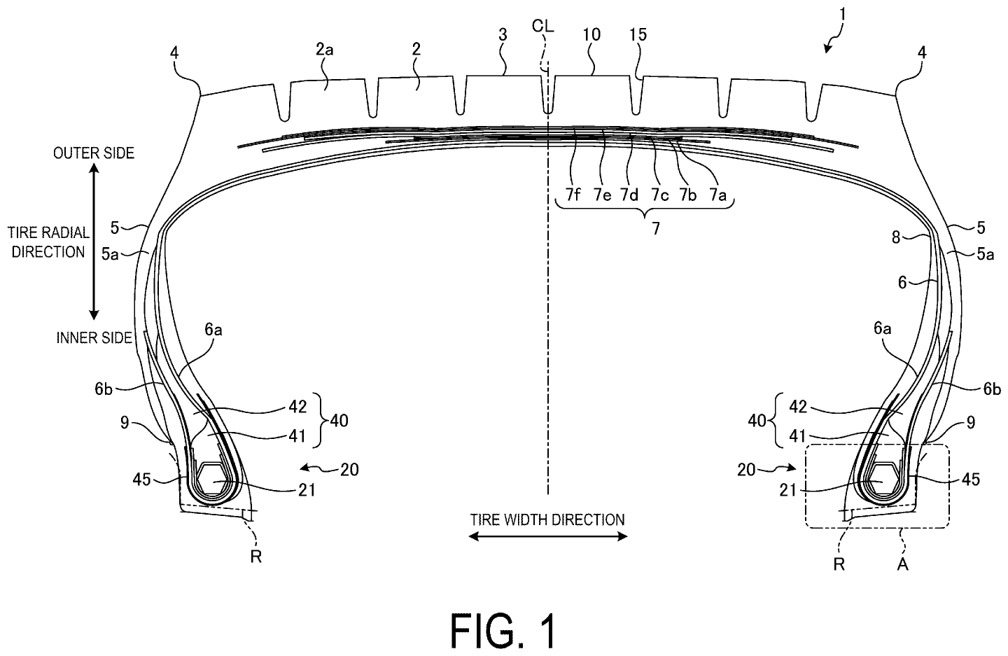

FIG. 1 is a meridian cross-sectional view illustrating a main portion of the pneumatic tire 1 according to a first embodiment. The pneumatic tire 1 according to the first embodiment is a radial tire for a construction vehicle referred to as an off the road tire (OR tire). The pneumatic tire 1 illustrated in FIG. 1 as the first embodiment is provided with a tread portion 2 in an outermost projection portion in the tire radial direction as viewed in the tire meridian cross-section, and the tread portion 2 is formed of a tread rubber 2a that is a rubber composition. The surface of the tread portion 2, that is, a portion that comes into contact with a road surface during traveling of a vehicle (not illustrated) mounted with the pneumatic tire 1, is formed as a tread contact surface 3.

A plurality of grooves, such as circumferential grooves 15 extending in the tire circumferential direction and lug grooves extending in the tire width direction, (not illustrated) are formed in the tread contact surface 3 of the tread portion 2, and a plurality of land portions 10 are defined and formed in the tread portion 2 by the grooves.

Both ends of the tread portion 2 in the tire width direction are formed as shoulder portions 4. Sidewall portions 5 are disposed from the shoulder portions 4 to predetermined positions inner side in tire radial direction. In other words, the sidewall portions 5 are disposed at two positions on both sides of the pneumatic tire 1 in the tire width direction. The sidewall portion 5 includes a sidewall rubber 5a, which is a rubber composition. Additionally, a rim check line 9 is formed at a position on a more inner side in the tire radial direction in each of the sidewall portions 5 on both sides in the tire width direction. The rim check line 9 projects from the surface of the sidewall portion 5 and is formed all around the circumference in the tire circumferential direction.

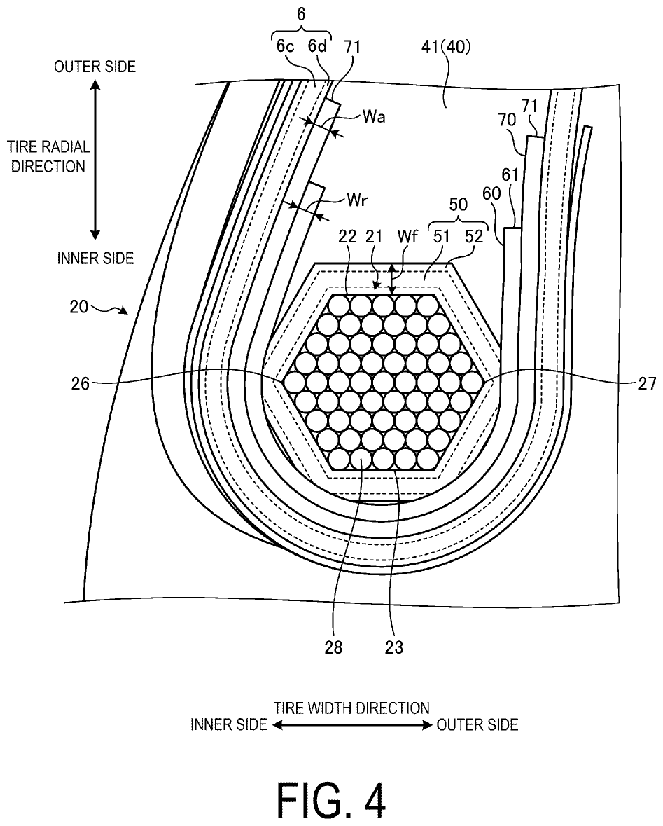

Furthermore, a bead portion 20 is located on the inner side of each sidewall portion 5 in the tire radial direction, and similar to the sidewall portions 5, the bead portions 20 are disposed at two positions on both sides of the tire equatorial plane CL. In other words, a pair of the bead portions 20 are disposed on both sides of the tire equatorial plane CL in the tire width direction. Bead cores 21 are disposed in the pair of respective bead portions 20, and a bead filler 40 is disposed on an outer side of each of the bead cores 21 in the tire radial direction. The head core 21 is formed by winding bead wires 28 (see FIG. 4), which are steel wires, into a ring shape. The bead filler 40 is a rubber material disposed in a space formed by folding back an end portion of a carcass 6 described later in the tire width direction to the outer side in the tire width direction at the position of the head core 21. Additionally, the bead filler 40 includes a lower filler 41 disposed so as to abut on an outer circumferential surface of the bead core 21, and an upper filler 42 disposed at a position further close to the outer side in the tire radial direction than the lower filler 41.

The head portion 20 is configured to be mountable on a rim wheel including a 5°-tapered specified rim R. In other words, the pneumatic tire 1 according to the first embodiment can be mounted on the specified rim R including a portion fitted to the bead portion 20 that is inclined in a direction toward the outer side in the tire radial direction as the portion extends from the inner side toward the outer side in the tire width direction at an inclination angle of 5°±1° with respect to the rotation axis of the rim wheel. Note that “specified rim” refers to an “applicable rim” defined by the JATMA (The Japan Automobile Tyre Manufacturers Association, Inc.), a “Design Rim” defined by the TRA (The Tire and Rim Association, Inc.), or a “Measuring Rim” defined by the ETRTO (The European Tyre and Rim Technical Organisation).

A belt layer 7 is provided on the inner side of the tread portion 2 in the tire radial direction. The belt layer 7 has a multilayer structure in which three or more belt plies are layered, and in a typical OR tire, four to eight belt plies are layered. In the first embodiment, the belt layer 7 is layered with six belt plies 7a, 7b, 7c, 7d, 7e, and 7f. The belt plies 7a, 7b, 7c, 7d, 7e, and 7f provided with the belt layer 7 are formed by coating a plurality of belt cords made from steel or an organic fiber material with coating rubber and rolling the resultant belt cords. Additionally, the belt cords of the belt plies 7a. 7b, 7c, 7d, 7e, and 7f have mutually different inclination angles in the tire width direction with respect to the tire circumferential direction, and the belt plies 7a, 7b, 7c, 7d, 7e, and 7f are layered such that the inclination directions of the belt cords intersect with one another, and are thus configured into a what is called crossply structure. Thus, the structural strength of the belt layer 7 is increased. The six belt plies 7a, 7b, 7c, 7d, 7e, and 7f include, for example, cross belts 7a, 7b, 7c, and 7d, and protective belt layer 7e and 7f.

The carcass 6 that includes a code of a radial ply is provided in a continuous manner on the inner side of the belt layer 7 in the tire radial direction and on the tire equatorial plane CL side of the sidewall portion 5. The carcass 6 has a single layer structure made from one carcass ply or a multilayer structure made from a plurality of layered carcass plies, and extends between the bead cores 21 disposed on both sides in the tire width direction in a toroidal shape, forming the backbone of the tire. Specifically, the carcass 6 is extended between the pair of bead portions 20, and is disposed extending from one bead portion 20 of the pair of bead portions 20 to the other bead portion 20 located on both sides in the tire width direction. Additionally, the carcass 6 runs through the inner side of the bead core 21 in the tire radial direction from the inner side of the bead core 21 in the tire width direction and is folded back to the outer side in the tire width direction in the bead portion 20 so as to wrap around the bead core 21 and the bead filler 40. In other words, the carcass 6 is folded back around the bead core 21 from the inner side of the bead core 21 in the tire width direction to the outer side of the bead core 21 in the tire width direction in the bead portion 20.

Thus, the carcass 6 includes a carcass body portion 6a disposed between the pair of bead portions 20 and a turned-up portion 6b formed continuous from the carcass body portion 6a and folded back from the inner side in the tire width direction to the outer side in the tire width direction of the bead core 21. The carcass body portion 6a referred to herein is a portion formed between the inner sides of the pair of bead cores 21 in the tire width direction in the carcass 6, and the turned-up portion 6b is a portion formed continuously from the carcass body portion 6a on the inner side of the bead core 21 in the tire width direction, running through the inner side of the bead core 21 in the tire radial direction, and folded back to the outer side in the tire width direction. The bead filler 40 is disposed on the inner side of the turned-up portion 6b in the tire width direction, which is a portion thus folded back to the outer side of the bead core 21 in the tire width direction, and on the outer side of the bead core 21 in the tire radial direction.

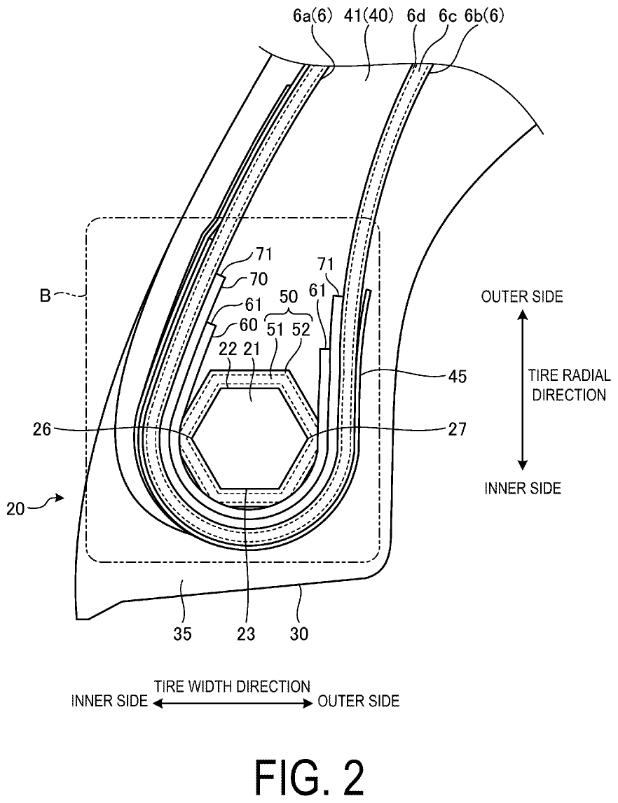

The carcass ply of the carcass 6 disposed in this manner is formed by coating a plurality of carcass cords 6c (see FIG. 2) as cord members made from steel or an organic fiber material, such as aramid, nylon, polyester, or rayon, with a coating rubber 6d (see FIG. 2), which is a rubber member, and rolling the resultant cords. Additionally, the carcass 6 has a carcass angle of 85° or more and 95° or less; the carcass angle being the inclination angle of the carcass cords 6c with respect to the tire circumferential direction.

Additionally, an inner liner 8 is formed along the carcass 6 on the inner side of the carcass 6 or on the inner side of the carcass 6 in the pneumatic tire 1.

FIG. 2 is a detailed view of portion A of FIG. 1. The bead core 21 is formed to have a polygonal cross-section as viewed in the tire meridian cross-section. In the first embodiment, the bead core 21 is formed to have a substantially hexagonal cross-sectional shape. Specifically, the bead core 21 is formed such that a bead core bottom 23 corresponding to an inner circumferential surface of the bead core 21 and an outer circumferential surface 22 of the bead core in the overall view of the bead core 21 are substantially parallel to each other, and the bead core 21 is formed, at positions on the respective end sides in the tire width direction, in a substantially hexagonal shape having corner portions projecting in the tire width direction, the bead core bottom 23, which is an inner circumferential surface of the bead cores 21 when viewed throughout the bead core 21, and has corner portions projecting in the tire width direction at positions on both end sides in the tire width direction. In other words, the bead core 21 is formed between the outer circumferential surface 22 and the bead core bottom 23 in the tire radial direction having a bead core innermost point 26 as an innermost apex in the tire width direction and a bead core outermost point 27 as an outermost apex in the tire width direction.

Note that in this case, the bead core bottom 23 of the bead core 21 refers to, in the tire meridian cross-section, a surface indicated by an imaginary straight line contacting a portion of a plurality of the bead wires 28 (see FIG. 4) disposed in a row at a position on the inner side of the bead core 21 in the tire radial direction to form the surface of the bead core 21, the portion being exposed from the surface side of the bead core 21. Similarly, the outer circumferential surface 22 of the bead core 21 refers to, in a case where the pneumatic tire 1 is viewed in the tire meridian cross-section, a surface indicated by an imaginary straight line contacting a portion of the plurality of bead wires 28 disposed in a row at a position on the outer side of the bead core 21 in the tire radial direction to form the surface of the bead core 21, the portion being exposed from the surface side of the bead core 21.

The bead portion 20 includes a bead base portion 30 located on the inner circumferential surface of the bead portion 20. The bead base portion 30 is located on the inner side of the bead core 21 in the tire radial direction and is formed to be inclined with respect to the tire rotation axis in a direction in which the bead base portion 30 expands toward the outer side in the tire radial direction as the bead base portion 30 extends from the inner side in the tire width direction toward the outer side in the tire width direction.

A chafer as a reinforcing layer reinforcing the carcass 6 is disposed in a portion of the carcass 6 that is folded back around the bead core 21. Examples of the chafer applied include a steel chafer formed using steel cords as cord members, or a nylon chafer formed using cord members made from an organic fiber material. The nylon chafer includes, for example, a sheet-shaped member formed by arranging and rolling a plurality of organic fiber cords, a fabric formed by weaving a plurality of organic fiber cords, or a composite material formed by rubberizing the sheet-shaped member or the fabric. In the first embodiment, a steel chafer 45 using a steel cord is disposed as the chafer.

The steel chafer 45 is disposed on the outer side of the carcass 6 at the folded back portion of the carcass 6 to be stacked with the carcass 6, similar to the carcass 6, folded back around the bead core 21 from the inner side to the outer side in the tire width direction, and disposed continuously in the tire circumferential direction. In other words, in a portion where the carcass 6 is located further on the inner side in the tire width direction than the bead core 21, the steel chafer 45 is located on the inner side of the carcass 6 in the tire width direction, and in a portion where the carcass 6 is located further on the inner side in the tire radial direction than the bead core 21, the steel chafer 45 is located on the inner side of the carcass 6 in the tire radial direction, and in a portion where the carcass 6 is located further on the outer side in the tire width direction than the bead core 21, the steel chafer 45 is located on the outer side of the carcass 6 in the tire width direction.

A rim cushion rubber 35 is disposed on the outer side of the steel chafer 45 in the bead portion 20. Similar to the steel chafer 45, the rim cushion rubber 35 is disposed from the inner side of the bead core 21 in the tire width direction to the inner side of the bead core 21 in the tire radial direction and the outer side of the bead core 21 in the tire width direction, and is provided continuously in the tire circumferential direction. The rim cushion rubber 35 disposed in this manner forms a contact surface of the bead portion 20 for a flange of the specified rim R.

The bead portion 20 further includes an inner organic fiber reinforced layer 50, a rubber reinforcing layer 60, and a rubber adhesive layer 70. Among them, the inner organic fiber reinforced layer 50 is wound around the entire circumference of the bead core 21 with respect to the bead core 21 in the tire meridian cross-section.

The rubber reinforcing layer 60 is disposed between the inner organic fiber reinforced layer 50 and the carcass 6 to cover from the outer side of the inner organic fiber reinforced layer 50 to at least the bead core innermost point 26, which is the apex on the innermost side of the bead core 21 in the tire width direction. In the present embodiment, the rubber reinforcing layer 60 between the inner organic fiber reinforced layer 50 and the carcass 6 runs through the inner side of the bead core 21 in the tire radial direction and is disposed from the inner side of the bead core 21 in the tire width direction to the outer side of the bead core 21 in the tire width direction. In other words, in the tire meridian cross-section, when a direction approaching the center of gravity of the bead core 21 is defined as an inner side direction based on the bead core 21 and a direction away from the center of gravity of the bead core 21 is defined as an outer side direction based on the bead core 21, the rubber reinforcing layer 60 is disposed on the outer side of the inner organic fiber reinforced layer 50 based on the bead core 21.

The rubber adhesive layer 70 between the rubber reinforcing layer 60 and the carcass 6 runs through the inner side of the bead core 21 in the tire radial direction and is disposed from the inner side of the bead core 21 in the tire width direction to the outer side of the bead core 21 in the tire width direction. In other words, the rubber adhesive layer 70 is disposed on the outer side of the rubber reinforcing layer 60 based on the bead core 21 in the tire meridian cross-section.

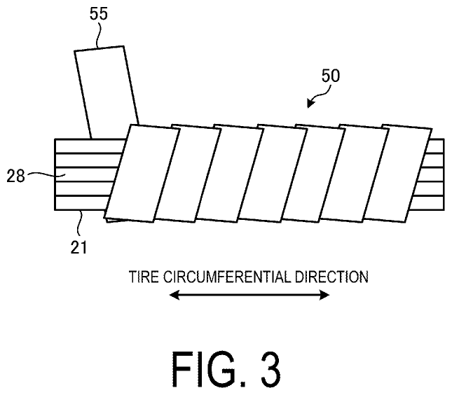

FIG. 3 is an explanatory diagram illustrating a state in which the inner organic fiber reinforced layer 50 illustrated in FIG. 2 is wound around the bead core 21. The inner organic fiber reinforced layer 50 wound around the bead core 21 is formed by spirally winding an inner organic fiber reinforced material 55, which is a band-like member, around the bead core 21 extending in the tire circumferential direction. In other words, the head core 21 is formed by winding one or a plurality of the bead wires 28 made from steel in a ring shape in multiple layers, and the inner organic fiber reinforced layer 50 is formed by spirally winding the inner organic fiber reinforced material 55 on the outer side of the bead wires 28 wound in multiple layers.

In other words, in the inner organic fiber reinforced layer 50, the inner organic fiber reinforced material 55 is spirally wound around the surface of the bead core 21 along the extension direction of the bead core 21 with the bead core 21 extending in the tire circumferential direction as the center of the spiral. At this time, the inner organic fiber reinforced material 55 is spirally wound while adjacent circumferential portions are in contact with one another. In other words, the inner organic fiber reinforced material 55 is spirally wound while the adjacent circumferential portions butt one another or are overlapped. In the first embodiment, the inner organic fiber reinforced material 55 is wound while a part of the adjacent circumferential portions in the width direction of the inner organic fiber reinforced material 55 formed in the band-like shape are overlapped. Thus, the inner organic fiber reinforced layer 50 is gaplessly wound around the entire surface of the bead core 21. The head wires 28 wound in multiple layers are bundled by the inner organic fiber reinforced layer 50 wound around the bead core 21 in this way and are prevented from coming apart.

The rubber reinforcing layer 60 is disposed on the outer side of the inner organic fiber reinforced layer 50 based on the bead core 21 with respect to the inner organic fiber reinforced layer 50 formed in this way, and is disposed along the carcass 6 such that the shape in the tire meridian cross-section is a U-shape in which the outer side in the tire radial direction is an opening side. In other words, the rubber reinforcing layer 60 is disposed along the carcass body portion 6a and the turned-up portion 6b of the carcass 6, and the bead core 21 around which the inner organic fiber reinforced layer 50 is wound is disposed on the inner side of the U-shape of the rubber reinforcing layer 60, which is disposed in the U-shape along the carcass 6.

Specifically, in the rubber reinforcing layer 60, an outer end portion 61, which is an end portion on the outer side in the tire radial direction, is located further on the outer side in the tire radial direction than the outer circumferential surface 22 of the bead core 21. Specifically, in the rubber reinforcing layer 60 formed in the U-shape in the tire meridian cross-section, both of the outer end portion 61 of a portion located further on the inner side in the tire width direction than the bead core 21 and the outer end portion 61 of a portion located further on the outer side in the tire width direction than the bead core 21 are located further on the outer side in the tire radial direction than the outer circumferential surface 22 of the bead core 21. Therefore, the rubber reinforcing layer 60 is disposed to cover the bead core innermost point 26 of the bead core 21 from the inner side of the bead core 21 in the tire width direction and cover the bead core outermost point 27 of the bead core 21 from the outer side of the bead core 21 in the tire width direction.

Further, the rubber adhesive layer 70, which is disposed between the rubber reinforcing layer 60 and the carcass 6, is disposed on the outer side of the rubber reinforcing layer 60 based on the bead core 21 with respect to the rubber reinforcing layer 60, and is disposed along the carcass 6 such that the shape in the tire meridian cross-section is a U-shape in which the outer side in the tire radial direction is an opening side similar to the rubber reinforcing layer 60. In other words, the rubber adhesive layer 70 is disposed along the carcass body portion 6a and the turned-up portion 6b of the carcass 6 on the outer side of the rubber reinforcing layer 60, and the rubber reinforcing layer 60 is disposed on the inner side of the U-shape of the rubber adhesive layer 70, which is disposed in the U-shape along the carcass 6.

Specifically, in the rubber adhesive layer 70 formed in the U-shape in the tire meridian cross-section, outer end portions 71, which are the end portions on the outer side in the tire radial direction at both of the inner side position and the outer side position of the bead core 21 in the tire width direction, are located further on the outer side in the tire radial direction than the outer end portions 61 of the rubber reinforcing layer 60. In other words, in the portions located on the inner side in the tire width direction of the bead core 21 of the rubber adhesive layer 70 and the rubber reinforcing layer 60, the outer end portions 71 of the rubber adhesive layer 70 are located further on the outer side in the tire radial direction than the outer end portions 61 of the rubber reinforcing layer 60. Similarly, in the portions located on the outer side of the bead core 21 in the tire width direction of the rubber adhesive layer 70 and the rubber reinforcing layer 60, the outer end portions 71 of the rubber adhesive layer 70 are located further on the outer side in the tire radial direction than the outer end portions 61 of the rubber reinforcing layer 60.

In the portions of the rubber adhesive layer 70 and the rubber reinforcing layer 60 located on the same side with respect to the bead core 21 in the tire width direction, the outer end portion 71 of the rubber adhesive layer 70 is preferably located on the outer side in the tire radial direction with respect to the outer end portion 61 of the rubber reinforcing layer 60 in the range of 5 mm or more and 15 mm or less.

The outer surface of the rubber adhesive layer 70 based on the bead core 21, that is, the surface on the side facing the carcass 6 is disposed in close contact with the carcass 6. The outer surface of the rubber reinforcing layer 60 based on the bead core 21, that is, the surface on the side facing the rubber adhesive layer 70 is disposed in close contact with the rubber adhesive layer 70. Further, the surface of the rubber reinforcing layer 60 on the side facing the inner organic fiber reinforced layer 50 is disposed in close contact with the inner organic fiber reinforced layer 50 at least in a range from the bead core innermost point 26 to the bead core outermost point 27 of the bead core 21 running through the bead core bottom 23 side in the tire meridian cross-section.

Among the inner organic fiber reinforced layer 50, the rubber reinforcing layer 60, and the rubber adhesive layer 70 disposed as described above, the inner organic fiber reinforced layer 50 wound around the bead core 21 is formed by coating an organic fiber cord 51, which is a cord member made from an organic fiber material, such as aramid, nylon, polyester, or rayon, with a coating rubber 52.

Specifically, in the inner organic fiber reinforced layer 50, in a state of the inner organic fiber reinforced material 55, which is the band-like member forming the inner organic fiber reinforced layer 50, the plurality of organic fiber cords 51 are disposed to be arranged in parallel in the width direction of the band, and each of the organic fiber cords 51 is disposed to extend in the length direction of the inner organic fiber reinforced material 55. The coating rubber 52 integrally coats the plurality of organic fiber cords 51 disposed to be arranged in the width direction of the band of the inner organic fiber reinforced material 55 as described above, thereby integrally holding the plurality of organic fiber cords 51. Further, since the organic fiber cord 51 is disposed to extend in the length direction of the inner organic fiber reinforced material 55, by the inner organic fiber reinforced material 55 being spirally wound around the bead core 21, the organic fiber cord 51 is also spirally wound around the bead core 21.

The rubber reinforcing layer 60 disposed on the outer side of the inner organic fiber reinforced layer 50 is formed of a sheet-like rubber member and has a rubber hardness harder than the rubber hardness of the surrounding rubber member. The rubber hardness of the rubber reinforcing layer 60 is, for example, harder than the rubber hardness of the coating rubber 52 of the inner organic fiber reinforced layer 50 and harder than the rubber hardness of the coating rubber 6d of the carcass 6. The rubber hardness of the rubber reinforcing layer 60 is equal to or more than the rubber hardness of the bead filler 40. Specifically, the rubber hardness of the rubber reinforcing layer 60 is equal to or more than the rubber hardness of the lower filler 41 of the bead filler 40 disposed abutting on the outer circumferential surface of the bead core 21.

Specifically, the rubber reinforcing layer 60) has a rubber hardness in the range of 80 or more and 85 or less. In the first embodiment, the rubber hardness is rubber hardness indicated by JIS (Japanese Industrial Standard)-A hardness in accordance with JIS K6253.

The rubber adhesive layer 70 disposed between the rubber reinforcing layer 60 and the carcass 6 on the outer side of the rubber reinforcing layer 60 is formed of a sheet-like rubber member and has a rubber hardness equal to or more than the rubber hardness of the coating rubber 6d of the carcass 6. The rubber hardness of the rubber adhesive layer 70 is softer than the rubber hardness of the rubber reinforcing layer 60, that is, the rubber hardness of the rubber reinforcing layer 60 is harder than the rubber hardness of the rubber adhesive layer 70. The rubber adhesive layer 70 formed in this manner has a rubber hardness in the range of 72 or more and 78 or less.

Since the rubber hardness of each rubber member has such a relationship, when the relationship is expressed using an inequality sign, the rubber hardness has the relationship of the coating rubber 6d of the carcass 6<the rubber adhesive layer 70<the rubber reinforcing layer 60, and also has the relationship of the coating rubber 52 of the inner organic fiber reinforced layer 50<the rubber reinforcing layer 60. The magnitude relationship of the rubber hardness in this case differs by 1 or more in the rubber hardness indicated by the JIS-A hardness.

A sulfur content contained in the rubber adhesive layer 70 is equal to or more than the sulfur content in the coating rubber 6d of the carcass 6, that is, the sulfur content in the rubber adhesive layer 70 represented by parts by mass is equal to or more than the sulfur content in the coating rubber 6d of the carcass 6. Specifically, the sulfur content contained in the rubber adhesive layer 70 is preferably in the range of 2 parts by mass or more and 10 parts by mass or less. Further, the rubber adhesive layer 70 is formed of a rubber member containing a cobalt compound.

FIG. 4 is a detailed view of portion B of FIG-. 2. The inner organic fiber reinforced layer 50, the rubber reinforcing layer 60, and the rubber adhesive layer 70 are interposed between the bead core 21 and the carcass 6. Among them, the inner organic fiber reinforced layer 50 has a thickness Wf in the range of 1 mm or more and 3 mm or less. The rubber reinforcing layer 60 has a thickness Wr in the range of 1 mm or more and 7 mm or less mm, and the rubber adhesive layer 70 has a thickness Wa in the range of 1 mm or more and 3 mm or less.

Since the respective members between the bead core 21 and the carcass 6 are formed to have the thicknesses, the shortest distance between the bead wire 28 provided with the bead core 21 and the carcass cord 6c provided with the carcass 6 is in the range of 3 mm or more and 10 mm or less. Here, the bead core 21 is formed to have a substantially hexagonal cross-sectional shape as a shape in the tire meridian cross-section. Therefore, the shortest distance between the bead wire 28 provided with the bead core 21 and the carcass cord 6c provided with the carcass 6 is the distance between the bead wire 28 located at any one of the corner portions of the bead core 21 formed in the substantially hexagonal cross-sectional shape and the carcass cord 6c provided with the carcass 6.

Therefore, the distance between the bead wire 28 located at the corner portion of the bead core 21 that projects to the outer side as viewed from the center side in the cross-sectional shape of the bead core 21 and the carcass cord 6c of the carcass 6 is 3 mm or more at any corner portion. Accordingly, for example, the distance between the bead core innermost point 26 and the carcass cord 6c provided with the carcass 6 is also 3 mm or more. Note that the shortest distance between the bead wire 28 and the carcass cord 6c is preferably in the range of 4 mm or more and 8 mm or less.

In a case where the pneumatic tire 1 configured as described above is mounted on a vehicle, first, the bead base portion 30 is fitted to the specified rim R provided with the rim wheel to mount the pneumatic tire 1 on the specified rim R, and the pneumatic tire 1 is mounted on the rim wheel. Once mounted on the rim, the pneumatic tire 1 is inflated, and the pneumatic tire 1 inflated is mounted on the vehicle. The pneumatic tire 1 according to the first embodiment is mounted on a large vehicle, such as a vehicle used in a mine, for example, and is used under a large load condition.

When the vehicle on which the pneumatic tires 1 are mounted travels, the pneumatic tire 1 rotates while the tread contact surface 3 located at the lower side in the tread contact surface 3 comes into contact with the road surface. The vehicle travels by transferring a driving force or a braking force to the road surface, using the friction force between the tread contact surface 3 and the road surface, or by generating a turning force.

During traveling of the vehicle having the pneumatic tires 1 mounted thereon, although the vehicle can travel with the aid of a friction force generated between the tread contact surface 3 of the pneumatic tire 1 and the road surface in this way, loads in various directions act on each portion of the pneumatic tire 1 during traveling of the vehicle. The load acting on the pneumatic tire 1 is received by the pressure of the air filled inside the pneumatic tire 1, the carcass 6 provided as the framework of the pneumatic tire 1, and the like.

For example, due to the weight of the vehicle and the recesses and protrusions of the road surface, the load acting in the tire radial direction between the tread portion 2 and the bead portion 20 is mainly received by the pressure of the air filled inside the pneumatic tire 1 or deflection of the sidewall portion 5 or the like. In particular, since the pneumatic tire 1 according to the first embodiment is mounted on a large vehicle and used under a condition of a large load, the sidewall portions 5 and the carcass 6 receive a very large load. Therefore, a large tensile force acts on the carcass 6.

The carcass 6 is folded back around the bead core 21 in the bead portion 20 to be held by the bead portion 20. Therefore, when a large tensile force acts on the carcass 6, the tensile force of the carcass 6 is transmitted to the bead core 21, and a large force acts between the carcass 6 and the bead core 21. In other words, since the carcass 6 is held by the bead portion 20 by being folded back around the bead core 21, when the tensile force acts on the carcass 6, a tensile force in a direction from the head portion 20 side toward the outer side in the tire radial direction acts on the carcass body portion 6a. Therefore, a large force also acts between the bead core 21 and the carcass 6 as well.

Here, the sidewall portion 5 is inclined with respect to the tire radial direction in a direction from the position of the bead portion 20 toward the outer side in the tire width direction as heading toward the outer side in the tire radial direction. Therefore, when a large tensile force acts on the carcass body portion 6a, while the carcass body portion 6a is pulled in the tire radial direction, the carcass body portion 6a generates a force in a direction toward the outer side in the tire width direction in the vicinity of the bead portion 20.

On the other hand, the bead core 21 is formed to have a substantially hexagonal cross-sectional shape in the tire meridian cross-section and has a plurality of corner portions in the tire meridian cross-section, and the bead core innermost point 26 is the corner portion projecting to the inner side in the tire width direction. Therefore, when a large tensile force acts on the carcass 6 and the carcass body portion 6a attempts to move in the tire radial direction due to the tensile force while generating a force in the outer side in the tire width direction in the vicinity of the bead portion 20, the carcass body portion 6a rubs against the bead core innermost point 26 while applying a large load thereto. As a result, in the carcass body portion 6a, the coating rubber 6d wears and the carcass cord 6c directly rubs, and there is a possibility that a failure, such as break of the carcass cord 6c, occurs.

In addition, since the carcass 6 is folded back around the bead core 21, when a large tensile force acts on the carcass 6, the carcass 6 and the bead core 21 rub against one another also at a position other than the bead core innermost point 26, and the carcass 6 possibly causes a failure, such as break of the carcass cord 6c, due to the rubbing.

On the other hand, in the pneumatic tire 1 according to the first embodiment, the inner organic fiber reinforced layer 50 is wound around the bead core 21, and the rubber reinforcing layer 60 covering at least the bead core innermost point 26 is disposed between the inner organic fiber reinforced layer 50 and the carcass 6. Thus, even when a large force acts between the carcass 6 and the bead core 21 due to a large tensile force acting on the carcass 6, the force acting between the carcass 6 and the bead core 21 can be dispersed by the rubber reinforcing layer 60 having elasticity and a hard rubber hardness. Therefore, wear of the coating rubber 6d due to the force acting between the carcass 6 and the bead core 21 can be suppressed, and a failure, such as break of the carcass cord 6c, can be suppressed.

Further, since the shortest distance between the bead wire 28 of the bead core 21 and the carcass cord 6c of the carcass 6 is 3 mm or more, even when a large force acts between the carcass 6 and the bead core 21, the force is easily dispersed by the rubber member or the like between the bead wires 28 and the carcass cord 6c. As a result, stress concentration when a large force acts between the carcass 6 and the bead core 21 can be alleviated, and, for example, stress concentration between the corner portion of the bead core 21 formed in the substantially hexagonal cross-sectional shape and the carcass 6 and can be alleviated. Therefore, a failure, such as break of the carcass cord 6c, can be more reliably suppressed. As a result, the durability of the bead portion 20 can be improved.

Further, since the rubber adhesive layer 70 having the rubber hardness equal to or more than the rubber hardness of the coating rubber 6d of the carcass 6 is disposed between the rubber reinforcing layer 60 and the carcass 6, even when a large force acts between the carcass 6 and the bead core 21, the force can be further dispersed by the rubber adhesive layer 70. Furthermore, the rubber hardness of the rubber reinforcing layer 60 is harder than the rubber hardness of the rubber adhesive layer 70 and the rubber hardness of the coating rubber 52 of the inner organic fiber reinforced layer 50. Therefore, a failure of the carcass 6 caused by the force acting between the carcass 6 and the bead. core 21 can be more reliably suppressed by the rubber reinforcing layer 60 and the rubber adhesive layer 70.

Further, since the sulfur content of the rubber adhesive layer 70 is equal to or more than the sulfur content of the coating rubber 6d of the carcass 6, flow of the sulfur component of the coating rubber 6d of the carcass 6 to the rubber adhesive layer 70 can be suppressed, and separation between the coating rubber 6d and the carcass cord 6c of the carcass 6 can be suppressed. In other words, since the sulfur component of the coating rubber 6d also serves as an adhesive component in the coating rubber 6d, when the sulfur component of the coating rubber 6d flows out, the adhesive component decreases, and thus separation is likely to occur between the coating rubber 6d and the carcass cord 6c. Here, when the rubber members are in contact with one another, the sulfur component contained in the rubber member generally flows out from the rubber member having a relatively large sulfur content to the rubber member having a small sulfur content. Therefore, when the sulfur content in the rubber adhesive layer 70 disposed in contact with the carcass 6 is smaller than the sulfur content in the coating rubber 6d of the carcass 6, the sulfur component in the coating rubber 6d is likely to flow to the rubber adhesive layer 70.

On the other hand, in the first embodiment, since the sulfur content in the rubber adhesive layer 70 disposed in contact with the carcass 6 is equal to or more than the sulfur content in the coating rubber 6d of the carcass 6, the outflow of the sulfur component from the coating rubber 6d of the carcass 6 to the rubber adhesive layer 70 can be suppressed. As a result, the decrease in adhesive component in the coating rubber 6d of the carcass 6 can be suppressed, and separation between the coating rubber 6d and the carcass cord 6c can be suppressed. Therefore, not only break of the carcass cord 6c is suppressed, but also separation between the carcass cord 6c and the coating rubber 6d can be suppressed, and a failure of the bead portion 20 can be more reliably suppressed. As a result, the durability of the bead portion 20 can be more reliably improved.

Further, since the rubber hardness of the rubber adhesive layer 70 is in the range of 72 or more and 78 or less, break of the carcass cord 6c can be more reliably suppressed while separation between the rubber adhesive layer 70 and the surrounding members is suppressed. In other words, in a case where the rubber hardness of the rubber adhesive layer 70 is less than 72, the rubber hardness of the rubber adhesive layer 70 is excessively soft, and thus the stress concentration between the carcass 6 and the bead core 21 is possibly difficult to be alleviated. In this case, break of the carcass cord 6c generated by the force acting between the carcass 6 and the bead core 21 is possibly difficult to be effectively suppressed. In addition, when the rubber hardness of the rubber adhesive layer 70 is more than 78, the rubber hardness of the rubber adhesive layer 70 is excessively hard, and thus the difference in rubber hardness between the rubber adhesive layer 70 and the coating rubber 6d of the carcass 6 possibly becomes excessively large. In this case, there is a possibility that separation is likely to occur due to an excessively large difference in rubber hardness between the rubber adhesive layer 70 and the coating rubber 6d of the carcass 6.

On the other hand, when the rubber hardness of the rubber adhesive layer 70 is in the range of 72 or more and 78 or less, while the excessively large difference in rubber hardness between the rubber adhesive layer 70 and the coating rubber 6d of the carcass 6 due to the rubber hardness of the rubber adhesive layer 70 being excessively hard is suppressed, the stress concentration between the carcass 6 and the bead core 21 can be more reliably alleviated. As a result, a failure, such as break of the carcass cord 6c, can be more reliably suppressed while separation between the rubber adhesive layer 70 and the carcass 6 is suppressed. As a result, the durability of the bead portion 20 can be more reliably improved.

In addition, in the portions of the rubber adhesive layer 70 and the rubber reinforcing layer 60 located on the inner side of the bead core 21 in the tire width direction, the outer end portion 71 of the rubber adhesive layer 70 is located further on the outer side in the tire radial direction than the outer end portion 61 of the rubber reinforcing layer 60, and thus contact of the rubber reinforcing layer 60 with the carcass 6 can be suppressed. As a result, outflow of the sulfur component from the coating rubber 6d of the carcass 6 to the rubber reinforcing layer 60 can be suppressed and a decrease in the adhesive component in the coating rubber 6d of the carcass 6 can be suppressed. Therefore, the separation between the coating rubber 6d and the carcass cord 6c can be more reliably suppressed.

Further, by locating the outer end portion 71 of the rubber adhesive layer 70 further on the outer side in the tire radial direction than the outer end portion 61 of the rubber reinforcing layer 60, a sudden change in rigidity between the rubber reinforcing layer 60 having the hard rubber hardness and the carcass 6 can be suppressed. In other words, by locating the outer end portion 71 of the rubber adhesive layer 70 further on the outer side in the tire radial direction than the outer end portion 61 of the rubber reinforcing layer 60 and forming a stepped shape, the difference in rigidity between the vicinity of the outer end portion 61 of the rubber reinforcing layer 60 and the surrounding members can be reduced. As a result, separation caused by the presence of a. portion having a large difference in rigidity between adjacent members can be suppressed. As a result, the durability of the bead portion 20 can be more reliably improved.

In addition, since the outer end portion 61 in the tire radial direction of the rubber reinforcing layer 60 is located further on the outer side in the tire radial direction than the outer circumferential surface 22 of the bead core 21, the rubber reinforcing layer 60 can be interposed in a further wide range between the bead core 21 and the carcass 6. Thus, the stress concentration when a large force acts between the carcass 6 and the bead core 21 can be more reliably alleviated by the rubber reinforcing layer 60, and a failure, such as break of the carcass cord 6c, can be more reliably suppressed. As a result, the durability of the bead portion 20 can be more reliably improved.

In addition, since the rubber adhesive layer 70 contains the cobalt compound, the adhesiveness of the rubber adhesive layer 70 can be enhanced. As a result, the rubber adhesive layer 70 can enhance the adhesiveness to both the carcass 6 and the rubber reinforcing layer 60 and the separation in the case where the rubber reinforcing layer 60 having a rubber hardness harder than those of the surrounding members is disposed can be more reliably suppressed. As a result, the durability of the bead portion 20 can be more reliably improved.

Further, since the shortest distance between the bead wire 28 and the carcass cord 6c is in the range of 4 mm or more and 8 mm or less, break of the carcass cord 6c can be more reliably suppressed while separation between the carcass 6 and the surrounding members is suppressed. In other words, when the shortest distance between the bead wire 28 and the carcass cord 6c is less than 4 mm, the shortest distance between the bead wire 28 and the carcass cord 6c is excessively small. Therefore, it is possibly difficult to alleviate the stress concentration between the carcass 6 and the bead core 21 when a large force acts between the carcass 6 and the bead core 21. In this case, break of the carcass cord 6c generated by the force acting between the carcass 6 and the bead core 21 is possibly difficult to be effectively suppressed. In addition, when the shortest distance between the bead wire 28 and the carcass cord 6c is more than 8 mm, the shortest distance between the bead wire 28 and the carcass cord 6c is excessively large, and thus the carcass 6 possibly excessively easily moves. In this case, since the carcass 6 excessively moves due to the force acting on the carcass 6, separation is possibly likely to occur between the carcass 6 and the surrounding members.

In contrast, when the shortest distance between the bead wire 28 and the carcass cord 6c is in the range of 4 mm or more and 8 mm or less, the stress concentration between the carcass 6 and the bead core 21 can be more reliably alleviated while excessive movement of the carcass 6 is suppressed. As a result, a failure, such as break of the carcass cord 6c, can be more reliably suppressed while separation between the carcass 6 and the surrounding members is suppressed. As a result, the durability of the bead portion 20 can be more reliably improved.

Further, since the rubber hardness of the rubber reinforcing layer 60 is in the range of 80 or more and 85 or less, break of the carcass cord 6c can be more reliably suppressed while separation between the rubber reinforcing layer 60 and the surrounding members is suppressed. In other words, in a case where the rubber hardness of the rubber reinforcing layer 60 is less than 80, the rubber hardness of the rubber reinforcing layer 60 is excessively soft, and thus the stress concentration between the carcass 6 and the bead core 21 is possibly difficult to be alleviated. In this case, break of the carcass cord 6c generated by the force acting between the carcass 6 and the bead core 21 is possibly difficult to be effectively suppressed. In addition, when the rubber hardness of the rubber reinforcing layer 60 is more than 85, the rubber hardness of the rubber reinforcing layer 60 is excessively hard, and thus the difference in rubber hardness between the rubber reinforcing layer 60 and the inner organic fiber reinforced layer 50 possibly becomes excessively large. In this case, there is a possibility that separation is likely to occur due to an excessively large difference in rubber hardness between the rubber reinforcing layer 60 and the inner organic fiber reinforced layer 50.

On the other hand, when the rubber hardness of the rubber reinforcing layer 60 is in the range of 80 or more and 85 or less, while the excessively large difference in rubber hardness between the rubber reinforcing layer 60 and the inner organic fiber reinforced layer 50 due to the rubber hardness of the rubber reinforcing layer 60 being excessively hard is suppressed, the stress concentration between the carcass 6 and the bead core 21 can be more reliably alleviated. As a result, a failure, such as break of the carcass cord 6c, can be more reliably suppressed while separation between the rubber reinforcing layer 60 and the inner organic fiber reinforced layer 50 is suppressed. As a result, the durability of the bead portion 20 can be more reliably improved.

Further, since the rubber hardness of the rubber reinforcing layer 60 is equal to or more than the rubber hardness of the bead filler 40, the rubber hardness of the rubber reinforcing layer 60 can be more reliably ensured. Thus, the force acting between the carcass 6 and the bead core 21 can be more reliably dispersed by the rubber reinforcing layer 60 having the hard rubber hardness. Therefore, wear of the coating rubber 6d due to the force acting between the carcass 6 and the bead core 21 can be more reliably suppressed, and a failure, such as break of the carcass cord 6c, can be more reliably suppressed. As a result, the durability of the bead portion 20 can be more reliably improved.

### Second Embodiment

The pneumatic tire 1 according to the second embodiment has a configuration substantially similar to that of the pneumatic tire 1 according to the first embodiment, but has a feature that an outer organic fiber reinforced layer 80 is disposed on the outer side of the rubber reinforcing layer 60. Because the other configurations are identical to those of the first embodiment, descriptions thereof will be omitted and the identical reference numerals are used.

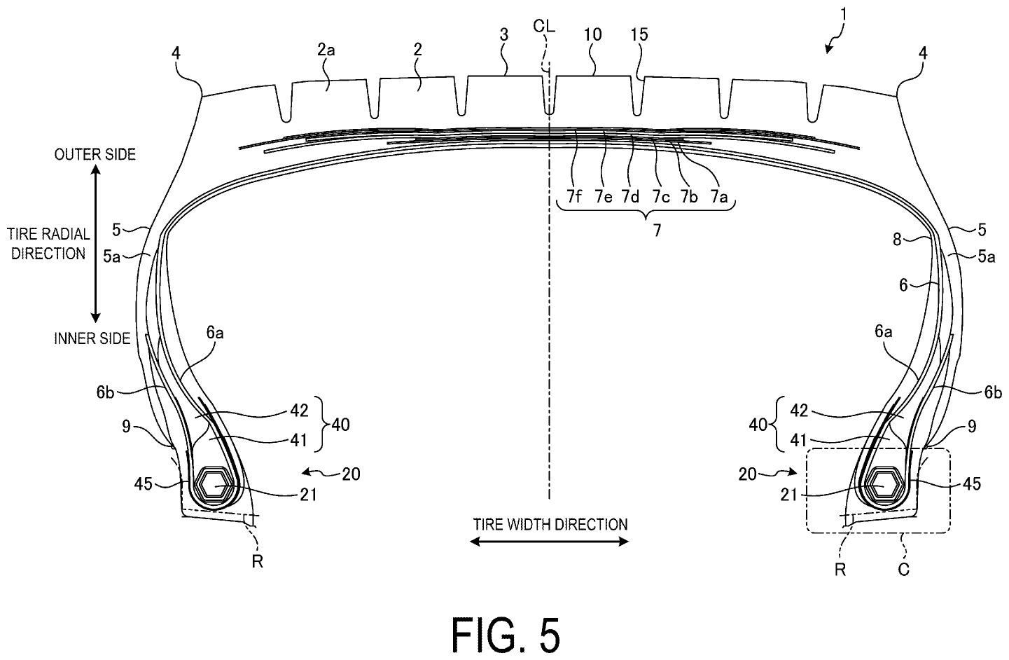

FIG. 5 is a meridian cross-sectional view illustrating a main portion of the pneumatic tire 1 according to the second embodiment. Similar to the pneumatic tire 1 according to the first embodiment, the pneumatic tire 1 according to the second embodiment is a radial tire for a construction vehicle referred to as an OR tire. In the pneumatic tire 1 according to the second embodiment, the pair of bead portions 20 are disposed on both sides of the tire equatorial plane CL in the tire width direction, and the bead core 21 is disposed in each of the pair of bead portions 20. In addition, the carcass 6 is extended between the bead portions 20 on both sides in the tire width direction, and the carcass 6 is disposed to pass through the inner side of the bead core 21 in the tire radial direction from the inner side of the bead core 21 in the tire width direction of the bead portion 20 and is folded back to the outer side in the tire width direction.

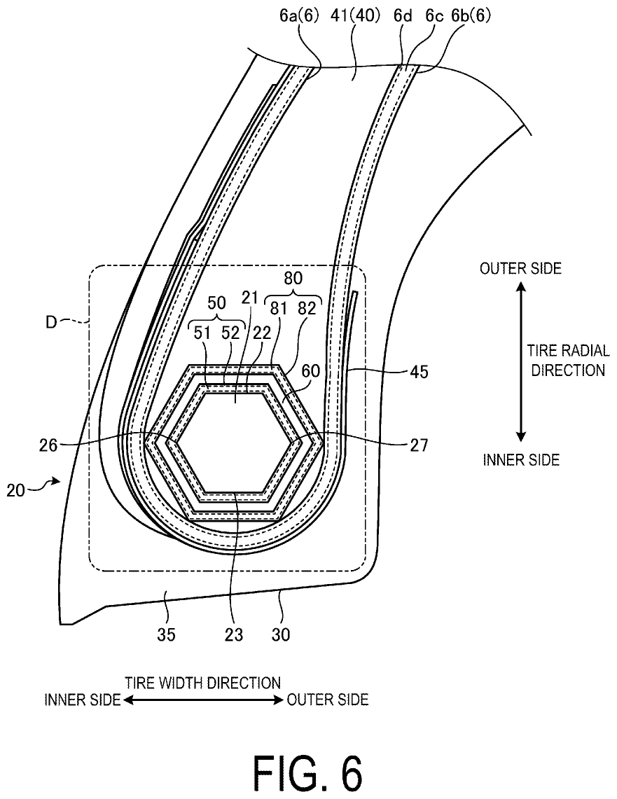

FIG. 6 is a detailed view of portion C of FIG. 5. Similar to the first embodiment, the bead core 21 is formed to have a substantially hexagonal cross-sectional shape as viewed in the tire meridian cross-section. Specifically, the bead core 21 is formed such that the bead core bottom 23 corresponding to an inner circumferential surface of the bead core 21 and the outer circumferential surface 22 of the bead core in the overall view of the bead core 21 are substantially parallel to each other, and the head core 21 is formed, at positions on the respective end sides in the tire width direction, in a substantially hexagonal shape having corner portions projecting in the tire width direction, the bead core bottom 23, which is an inner circumferential surface of the bead cores 21 when viewed throughout the bead core 21, and has corner portions projecting in the tire width direction at positions on both end sides in the tire width direction.

The inner organic fiber reinforced layer 50 and the rubber reinforcing layer 60 are disposed in the bead portion 20, and the inner organic fiber reinforced layer 50 is wound around the head core 21 over the entire circumference of the bead core 21 in the tire meridian cross-section. On the other hand, unlike the first embodiment, in the second embodiment, the rubber reinforcing layer 60 is wound around the entire circumference of the bead core 21 in the tire meridian cross-section from the outer side of the inner organic fiber reinforced layer 50 between the inner organic fiber reinforced layer 50 and the carcass 6. Thus, in the tire meridian cross-section, when a direction approaching the center of gravity of the bead core 21 is defined as an inner side direction based on the bead core 21 and a direction away from the center of gravity of the bead core 21 is defined as an outer side direction based on the bead core 21, the rubber reinforcing layer 60 is disposed on the outer side of the inner organic fiber reinforced layer 50 based on the bead core 21.

Furthermore, in the second embodiment, unlike the first embodiment, the rubber adhesive layer 70 is not disposed in the head portion 20, and the outer organic fiber reinforced layer 80 is disposed in the bead portion 20. The outer organic fiber reinforced layer 80 is disposed at least between the rubber reinforcing layer 60 and the carcass 6, runs through the inner side in the tire radial direction of the bead core 21 from the inner side of the bead core 21 in the tire width direction, and disposed extending to the outer side of the bead core 21 in the tire width direction. In the second embodiment, the outer organic fiber reinforced layer 80 is wound around the entire circumference of the bead core 21 in the tire meridian cross-section from the outer side of the rubber reinforcing layer 60.

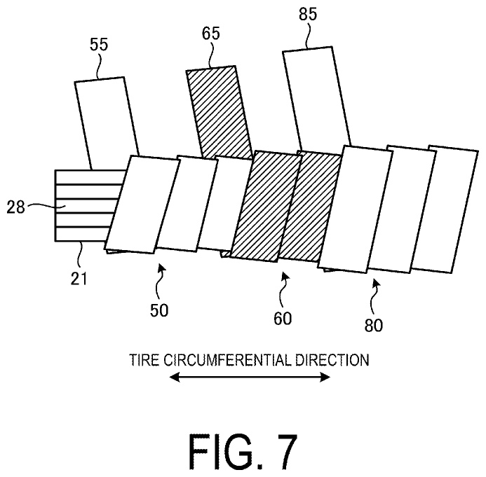

FIG. 7 is an explanatory diagram illustrating a state in which the inner organic fiber reinforced layer 50, the rubber reinforcing layer 60, and the outer organic fiber reinforced layer 80 illustrated in FIG. 6 are wound around the bead core 21. Similar to the first embodiment, the inner organic fiber reinforced layer 50 wound around the bead core 21 is formed by spirally winding the inner organic fiber reinforced material 55, which is a band-like member, around the bead core 21 extending in the tire circumferential direction.

The rubber reinforcing layer 60, which is wound around the entire circumference of the bead core 21 from the outer side of the inner organic fiber reinforced layer 50, is formed by spirally winding a rubber reinforcing material 65 as a band-like member around the bead core 21 extending in the tire circumferential direction from the outer side of the inner organic fiber reinforced material 55. In other words, in the rubber reinforcing layer 60, the rubber reinforcing material 65 is spirally wound around the bead core 21 around which the inner organic fiber reinforced material 55 is wound from the outer side of the inner organic fiber reinforced material 55 along the extension direction of the bead core 21 with the bead core 21 extending in the tire circumferential direction as the center of the spiral. At this time, the rubber reinforcing material 65 is spirally wound while adjacent circumferential portions are in contact with one another. For example, the rubber reinforcing material 65 is wound while a part of the adjacent circumferential portions in the width direction of the rubber reinforcing material 65 formed in the band-like shape are overlapped. As a result, the rubber reinforcing material 65 is gaplessly wound around the entire outer side of the inner organic fiber reinforced material 55 in the bead core 21 around which the inner organic fiber reinforced material 55 is wound.

The outer organic fiber reinforced layer 80 wound around the entire circumference of the bead core 21 from the outer side of the rubber reinforcing layer 60 is formed by spirally winding an outer organic fiber reinforced material 85, which is a band-like member, around the bead core 21 extending in the tire circumferential direction from the outer side of the rubber reinforcing material 65. In other words, in the outer organic fiber reinforced layer 80, the outer organic fiber reinforced material 85 is spirally wound around the bead core 21 around which the rubber reinforcing material 65 is wound from the outer side of the rubber reinforcing material 65 along the extension direction of the bead core 21 with the bead core 21 extending in the tire circumferential direction as the center of the spiral. At this time, the outer organic fiber reinforced material 85 is spirally wound while adjacent circumferential portions are in contact with one another. For example, the outer organic fiber reinforced material 85 is wound while a part of the adjacent circumferential portions in the width direction of the outer organic fiber reinforced material 85 formed in the band-like shape are overlapped. As a result, the outer organic fiber reinforced material 85 is gaplessly wound around the entire outer side of the rubber reinforcing material 65 in the bead core 21 around which the rubber reinforcing material 65 is wound.

In the inner organic fiber reinforced layer 50, the rubber reinforcing layer 60, and the outer organic fiber reinforced layer 80, the direction in which the inner organic fiber reinforced material 55 is spirally wound, the direction in which the rubber reinforcing material 65 is spirally wound, and the direction in which the outer organic fiber reinforced material 85 is spirally wound are all the same.

Similar to the first embodiment, the inner organic fiber reinforced layer 50 is formed by coating the organic fiber cord 51, which is a cord member made from an organic fiber material, such as aramid, nylon, polyester, or rayon, with the coating rubber 52. In other words, in the inner organic fiber reinforced layer 50, the inner organic fiber reinforced material 55 is spirally wound around the bead core 21, and thus the organic fiber cord 51 is also spirally wound around the bead core 21. The coating rubber 52 integrally coats the plurality of organic fiber cords 51 to integrally hold the plurality of organic fiber cords 51.

Similarly, the outer organic fiber reinforced layer 80 is formed by coating an organic fiber cord 81, which is a cord member made from an organic fiber material, with a coating rubber 82. In other words, in the outer organic fiber reinforced layer 80, in the state of the outer organic fiber reinforced material 85 as the band-like member, the plurality of organic fiber cords 81 extending in the length direction of the outer organic fiber reinforced material 85 are disposed to be arranged in parallel, and the coating rubber 82 integrally coats the plurality of organic fiber cords 81 to integrally hold the plurality of organic fiber cords 81. Further, since the organic fiber cord 81 is disposed to extend in the length direction of the outer organic fiber reinforced material 85, by the outer organic fiber reinforced material 85 being spirally wound from the outer side of the rubber reinforcing layer 60, the organic fiber cord 81 is also spirally wound around the bead core 21 around which the inner organic fiber reinforced layer 50 and the rubber reinforcing layer 60 are wound.

The rubber reinforcing material 65 forming the rubber reinforcing layer 60 disposed between the inner organic fiber reinforced layer 50 and the outer organic fiber reinforced layer 80 is a band-like rubber member. Therefore, the rubber reinforcing layer 60 formed by spirally winding the rubber reinforcing material 65 is a rubber member wound around the outer side of the inner organic fiber reinforced layer 50 and disposed between the inner organic fiber reinforced layer 50 and the outer organic fiber reinforced layer 80. The rubber hardness of the rubber reinforcing layer 60 is harder than, for example, the rubber hardness of the coating rubber 52 of the inner organic fiber reinforced layer 50 and the rubber hardness of the coating rubber 82 of the outer organic fiber reinforced layer 80, and is also harder than the rubber hardness of the coating rubber 6d of the carcass 6. The rubber hardness of the rubber reinforcing layer 60 is equal to or more than the rubber hardness of the lower filler 41 of the bead filler 40. In the second embodiment, similar to the first embodiment, the rubber reinforcing layer 60 has a rubber hardness in the range of 80 or more and 85 or less. In addition, in the second embodiment, similar to the first embodiment, the rubber hardness is rubber hardness indicated by JIS-A hardness in accordance with JIS K6253.

The inner organic fiber reinforced layer 50 disposed on the inner side of the rubber reinforcing layer 60 and the outer organic fiber reinforced layer 80 disposed on the outer side of the rubber reinforcing layer 60 include the organic fiber cords 51 and 81, respectively, and the thickness of the organic fiber cord 81 of the outer organic fiber reinforced layer 80 is equal to or more than the thickness of the organic fiber cord 51 of the inner organic fiber reinforced layer 50. The thickness of the organic fiber cords 81 of the outer organic fiber reinforced layer 80 is preferably in the range of 1.0 times or more and 2.5 times or less of the thickness of the organic fiber cords 51 of the inner organic fiber reinforced layer 50, Specifically, fineness of the organic fiber cord 51 of the inner organic fiber reinforced layer 50 is in the range of 700 dtex or more and 2000 dtex or less, and fineness of the organic fiber cord 81 of the outer organic fiber reinforced layer 80 is in the range of 700 dtex or more and 2000 dtex or less.

The rubber hardness of the coating rubber 82 of the outer organic fiber reinforced layer 80 is equal to or more than the rubber hardness of the coating rubber 52 of the inner organic fiber reinforced layer 50. Specifically, the coating rubber 52 of the inner organic fiber reinforced layer 50 has the rubber hardness in the range of 65 or more and 75 or less, and the coating rubber 82 of the outer organic fiber reinforced layer 80 has the rubber hardness in the range of 70 or more and 80 or less.

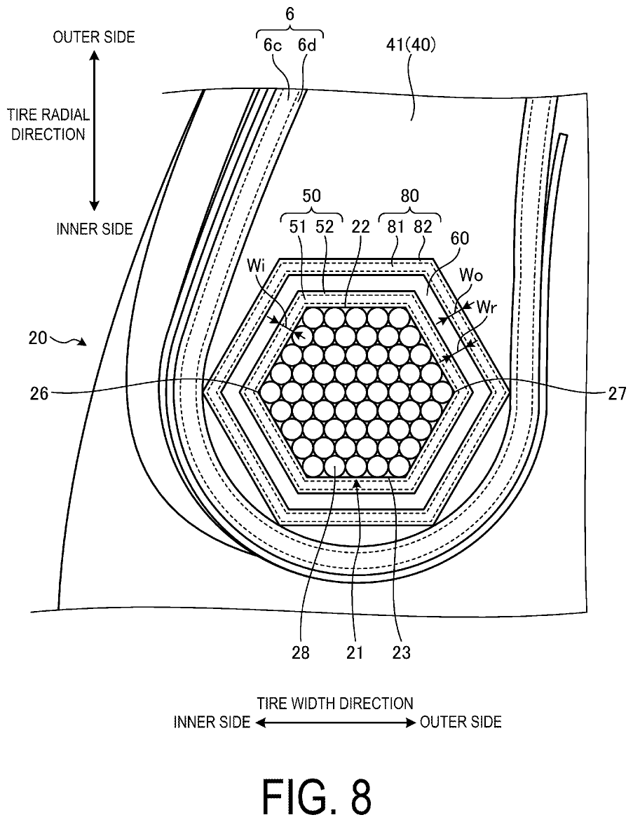

FIG. 8 is a detailed view of portion D of FIG. 6. The inner organic fiber reinforced layer 50, the rubber reinforcing layer 60, and the outer organic fiber reinforced layer 80 are interposed between the bead core 21 and the carcass 6. Among them, the inner organic fiber reinforced layer 50 has a thickness Wi in the range of 1 mm or more and 3 mm or less. The rubber reinforcing layer 60 has the thickness W r in the range of 1 mm or more and 8 mm or less, and the outer organic fiber reinforced layer 80 has a thickness Wo in the range of 1 mm or more and 3 mm or less.

Since the respective members between the bead core 21 and the carcass 6 are formed to have the thicknesses, the shortest distance between the bead wire 28 provided with the bead core 21 and the carcass cord 6c provided with the carcass 6 is in the range of 3 mm or more and 10 mm or less. Here, the bead core 21 is formed to have a substantially hexagonal cross-sectional shape as a shape in the tire meridian cross-section. Therefore, the shortest distance between the bead wire 28 provided with the bead core 21 and the carcass cord 6c provided with the carcass 6 is the distance between the bead wire 28 located at any one of the corner portions of the bead core 21 formed in the substantially hexagonal cross-sectional shape and the carcass cord 6c provided with the carcass 6.

Therefore, the distance between the head wire 28 located at the corner portion of the bead core 21 that projects to the outer side as viewed from the center side in the cross-sectional shape of the bead core 21 and the carcass cord 6c of the carcass 6 is 3 mm or more at any corner portion. Accordingly, for example, the distance between the bead core innermost point 26 and the carcass cord 6c provided with the carcass 6 is also 3 mm or more. Note that the shortest distance between the bead wire 28 and the carcass cord 6c is preferably in the range of 4 mm or more and 8 mm or less.

In a case where the pneumatic tire 1 configured as described above is mounted on a vehicle, similar to the pneumatic tire 1 according to the first embodiment, the pneumatic tire 1 is mounted on the specified rim R, and the pneumatic tire 1 is mounted on a rim wheel. Once mounted on the rim, the pneumatic tire 1 is inflated, and the pneumatic tire 1 inflated is mounted on the vehicle.

During traveling of the vehicle having the pneumatic tires 1 mounted thereon, loads in various directions act on each portion of the pneumatic tire 1. Since the pneumatic tire 1 according to the second embodiment is mounted on a large vehicle and used under a condition of a large load, the sidewall portions 5 and the carcass 6 receive a very large load. Therefore, a large tensile force acts on the carcass 6, and the carcass 6 rubs against the bead core innermost point 26 or the like of the bead core 21 while applying a large load thereto, and thus a failure, such as break of the carcass cord 6c, possibly occurs.

On the other hand, in the pneumatic tire 1 according to the second embodiment, the inner organic fiber reinforced layer 50 is wound around the bead core 21, and the rubber reinforcing layer 60 covering at least the bead core innermost point 26 is disposed between the inner organic fiber reinforced layer 50 and the carcass 6. Thus, even when a large force acts between the carcass 6 and the bead core 21 due to a large tensile force acting on the carcass 6, the force acting between the carcass 6 and the bead core 21 can be dispersed by the rubber reinforcing layer 60 having elasticity and a hard rubber hardness. Therefore, wear of the coating rubber 6d due to the force acting between the carcass 6 and the bead core 21 can be suppressed, and a failure, such as break of the carcass cord 6c, can be suppressed.

Furthermore, since the outer organic fiber reinforced layer 80 is disposed between the rubber reinforcing layer 60 and the carcass 6 and the rubber reinforcing layer 60 is covered with the outer organic fiber reinforced layer 80, the outflow of the rubber reinforcing layer 60 from a position between the carcass 6 and the bead core 21 during vulcanization molding of the pneumatic tire 1 can be suppressed. Accordingly, the force acting between the carcass 6 and the bead core 21 can be more reliably dispersed by the rubber reinforcing layer 60, and a failure, such as break of the carcass cord 6c, can be more reliably suppressed. As a result, the durability of the bead portion 20 can be improved.

Further, since the rubber hardness of the rubber reinforcing layer 60 is equal to or more than the rubber hardness of the coating rubber 52 of the inner organic fiber reinforced layer 50 and the coating rubber 82 of the outer organic fiber reinforced layer 80, the force acting between the carcass 6 and the bead core 21 can be more reliably dispersed by the rubber reinforcing layer 60 haying the hard rubber hardness. As a result, wear of the coating rubber 6d of the carcass 6 due to the force acting between the carcass 6 and the bead core 21 can be more reliably suppressed, and a failure, such as break of the carcass cord 6c, can be suppressed. As a result, the durability of the bead portion 20 can be more reliably improved.

In addition, since the thickness of the organic fiber cords 81 of the outer organic fiber reinforced layer 80 is equal to or more than the thickness of the organic fiber cords 51 of the inner organic fiber reinforced layer 50, a winding force of the outer organic fiber reinforced layer 80 with respect to the bead core 21 can be more reliably ensured. As a result, it can be more reliably suppressed that the bead wires 28 forming the bead core 21 come apart by the outer organic fiber reinforced layer 80, and collapse of the shape of the bead core 21 when a large force acts on the bead core 21 can be more reliably suppressed. In addition, since the organic fiber cords 81 of the outer organic fiber reinforced layer 80 are thick, the outflow of the rubber reinforcing layer 60 to the outer side of the outer organic fiber reinforced layer 80 during vulcanization molding of the pneumatic tire 1 can be more reliably suppressed by the outer organic fiber reinforced layer 80. Thus, the force acting between the carcass 6 and the bead core 21 can be more reliably dispersed by the rubber reinforcing layer 60. As a result, the durability of the bead portion 20 can be more reliably improved.

In addition, since the rubber hardness of the coating rubber 82 of the outer organic fiber reinforced layer 80 is equal to or more than the rubber hardness of the coating rubber 52 of the inner organic fiber reinforced layer 50, a winding force of the outer organic fiber reinforced layer 80 with respect to the bead core 21 can be more reliably ensured, and it can be more reliably suppressed that the bead wires 28 forming the bead core 21 come apart. In addition, since the rubber hardness of the coating rubber 82 of the outer organic fiber reinforced layer 80 is hard, the outflow of the rubber reinforcing layer 60 to the outer side of the outer organic fiber reinforced layer 80 during vulcanization molding of the pneumatic tire 1 can be more reliably suppressed by the outer organic fiber reinforced layer 80. Thus, the force acting between the carcass 6 and the bead core 21 can be more reliably dispersed by the rubber reinforcing layer 60. As a result, the durability of the bead portion 20 can be more reliably improved.

Further, the outer organic fiber reinforced layer 80 is formed by spirally winding the outer organic fiber reinforced material 85, and the outer organic fiber reinforced material 85 is spirally wound while adjacent circumferential portions are in contact with one another. Therefore, the outflow of the rubber reinforcing layer 60 from the position between the carcass 6 and the bead core 21 during vulcanization molding of the pneumatic tire 1 can be more reliably suppressed. In other words, when there is a gap in the spirally wound outer organic fiber reinforced material 85, there is a possibility that the rubber reinforcing layer 60 flows out from the gap. However, when the outer organic fiber reinforced material 85 is spirally wound while the adjacent circumferential portions butt one another or are overlapped, a gap of the outer organic fiber reinforced material 85 can be suppressed. As a result, during vulcanization molding of the pneumatic tire 1, it can be suppressed that the rubber reinforcing layer 60 located on the inner side of the outer organic fiber reinforced material 85 flows out from the gap of the outer organic fiber reinforced material 85 and flows out from the position between the carcass 6 and the bead core 21, and the rubber reinforcing layer 60 can be more reliably disposed between the carcass 6 and the bead core 21. Accordingly, the force acting between the carcass 6 and the bead core 21 can be more reliably dispersed by the rubber reinforcing layer 60, and a failure, such as break of the carcass cord 6c, can be more reliably suppressed. As a result, the durability of the bead portion 20 can be more reliably improved.

Further, in the inner organic fiber reinforced layer 50 and the outer organic fiber reinforced layer 80, since the direction in which the inner organic fiber reinforced material 55 is spirally wound is the same as the direction in which the outer organic fiber reinforced material 85 is spirally wound, the inner organic fiber reinforced material 55 and the outer organic fiber reinforced material 85 can be gaplessly wound more reliably. As a result, a gap can be suppressed on both of the inner side and the outer side of the rubber reinforcing layer 60, and the outflow of the rubber reinforcing layer 60 from the position between the carcass 6 and the bead core 21 during vulcanization molding of the pneumatic tire 1 can be more reliably suppressed. Therefore, the rubber reinforcing layer 60 can be more reliably disposed between the carcass 6 and the bead core 21, and a failure, such as break of the carcass cord 6c, can be more reliably suppressed. As a result, the durability of the bead portion 20 can be more reliably improved.

### MODIFIED EXAMPLES

In the pneumatic tire 1 according to the first embodiment described above, the outer end portions 61 of the rubber reinforcing layer 60 in the tire radial direction are located further on the outer side in the tire radial direction than the outer circumferential surface 22 of the bead core 21 on both of the inner side and the outer side of the bead core 21 in the tire width direction. However, the outer end portion 61 of the rubber reinforcing layer 60 need not be located further on the outer side in the tire radial direction than the outer circumferential surface 22 of the bead core 21.

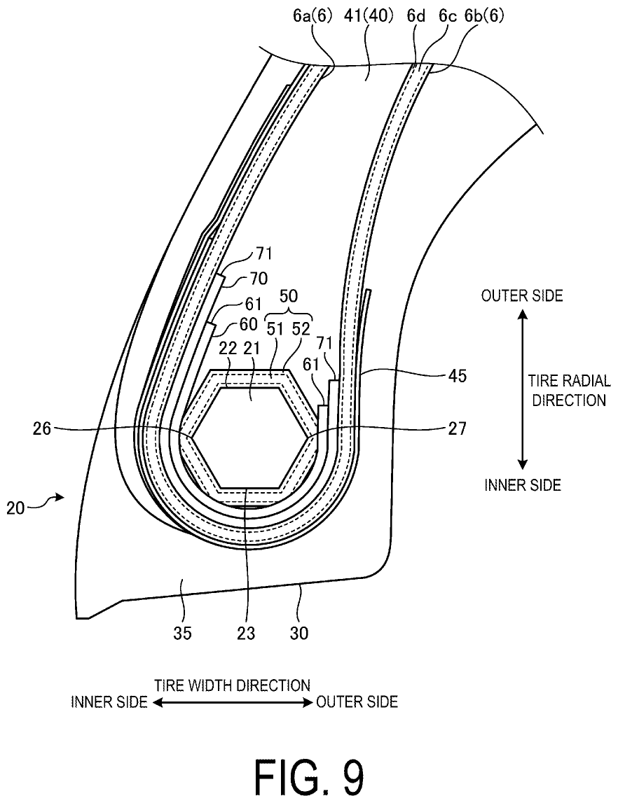

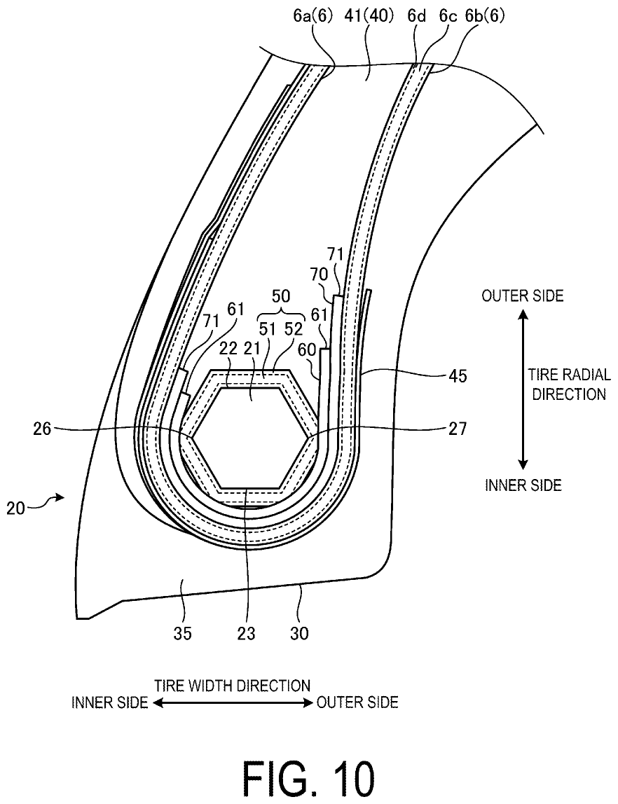

FIG. 9 is a modified example of the pneumatic tire 1 according to the first embodiment, and is an explanatory diagram of a state in which the outer end portion 61 of the rubber reinforcing layer 60 in the outer side in the tire width direction is located further on the inner side in the tire radial direction than the outer circumferential surface 22 of the bead core 21. FIG. 10 is a modified example of the pneumatic tire 1 according to the first embodiment, and is an explanatory diagram of a state in which the outer end portion 61 of the rubber reinforcing layer 60 on the inner side in the tire width direction is located further on the inner side in the tire radial direction than the outer circumferential surface 22 of the bead core 21. In the rubber reinforcing layer 60 of the pneumatic tire 1 according to the first embodiment, for example, as illustrated in FIG. 9, the outer end portion 61 located on the inner side of the bead core 21 in the tire width direction may be located further on the outer side in the tire radial direction than the outer circumferential surface 22 of the bead core 21, and the outer end portion 61 located on the outer side of the bead core 21 in the tire width direction may be located further on the inner side in the tire radial direction than the outer circumferential surface 22 of the bead core 21. In this case, the outer end portion 61 on the side located on the outer side of the bead core 21 in the tire width direction in the rubber reinforcing layer 60 is preferably located further on the outer side in the tire radial direction than the bead core outermost point 27 of the bead core 21.

Conversely, as illustrated in FIG. 10, in the rubber reinforcing layer 60 of the pneumatic tire 1 according to the first embodiment, the outer end portion 61 located on the outer side of the bead core 21 in the tire width direction may be located further on the outer side in the tire radial direction than the outer circumferential surface 22 of the bead core 21, and the outer end portion 61 located on the inner side of the bead core 21 in the tire width direction may be located further on the inner side in the tire radial direction than the outer circumferential surface 22 of the head core 21. In this case as well, the outer end portion 61 on the side located on the inner side of the bead core 21 in the tire width direction in the rubber reinforcing layer 60 is preferably located further on the outer side in the tire radial direction than the bead core innermost point 26 of the bead core 21.

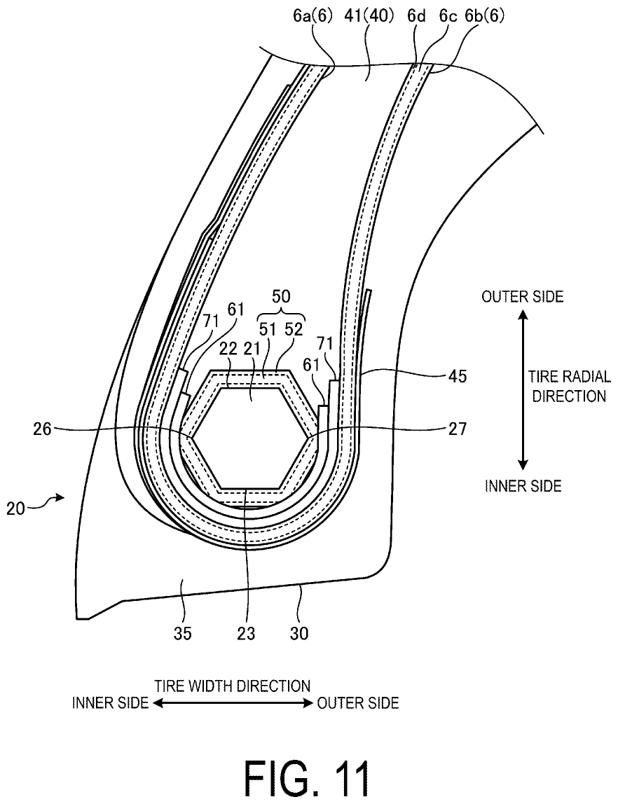

FIG. 11 is a modified example of the pneumatic tire 1 according to the first embodiment, and is an explanatory diagram of a state in which the outer end portions 61 of the rubber reinforcing layer 60 on both sides in the tire width direction are located further on the inner side in the tire radial direction than the outer circumferential surface 22 of the bead core 21. Furthermore, as illustrated in FIG, 11, in the rubber reinforcing layer 60 of the pneumatic tire 1 according to the first embodiment, the outer end portions 61 located on both sides of the bead core 21 in the tire width direction may be located further on the inner side in the tire radial direction than the outer circumferential surface 22 of the bead core 21. In this case as well, the outer end portion 61 on the side located on the inner side of the bead core 21 in the tire width direction in the rubber reinforcing layer 60 is preferably located further on the outer side in the tire radial direction than the bead core innermost point 26 of the bead core 21. The outer end portion 61 on the side located on the outer side of the bead core 21 in the tire width direction is preferably located further on the outer side in the tire radial direction than the bead core outermost point 27 of the bead core 21.

As described above, the outer end portions 61 located on both sides of the bead core 21 in the tire width direction in the rubber reinforcing layer 60 only need to be located further on the outer side in the tire radial direction than at least the bead core innermost point 26 and the bead core outermost point 27 of the bead core 21. Thus, the rubber reinforcing layer 60 can cover the range from the bead core innermost point 26 to the bead core outermost point 27 in the bead core 21, and therefore stress concentration at a position where stress concentration is likely to occur between the bead core 21 and the carcass 6 can be alleviated.

In other words, the bead core 21 is formed to have the substantially hexagonal cross-sectional shape, and the carcass 6 runs through the inner side of the bead core 21 in the tire radial direction from the inner side of the bead core 21 in the tire width direction and is folded back to the outer side in the tire width direction. Therefore, by covering the range from the bead core innermost point 26 to the bead core outermost point 27 with the rubber reinforcing layer 60, the portion covered with the carcass 6 at the corner portion in the cross-sectional shape of the bead core 21 can be covered with the rubber reinforcing layer 60 located between the bead core 21 and the carcass 6.

As a result, stress concentration in the vicinity of the corner portion in the cross-sectional shape of the bead core 21, which is a portion where stress concentration is likely to occur between the bead core 21 and the carcass 6, can be alleviated by the rubber reinforcing layer 60. Therefore, ease of wear of the coating rubber 6d by stress concentration can be suppressed, and break of the carcass cord 6c can be more reliably suppressed. As a result, the durability of the bead portion 20 can be improved.

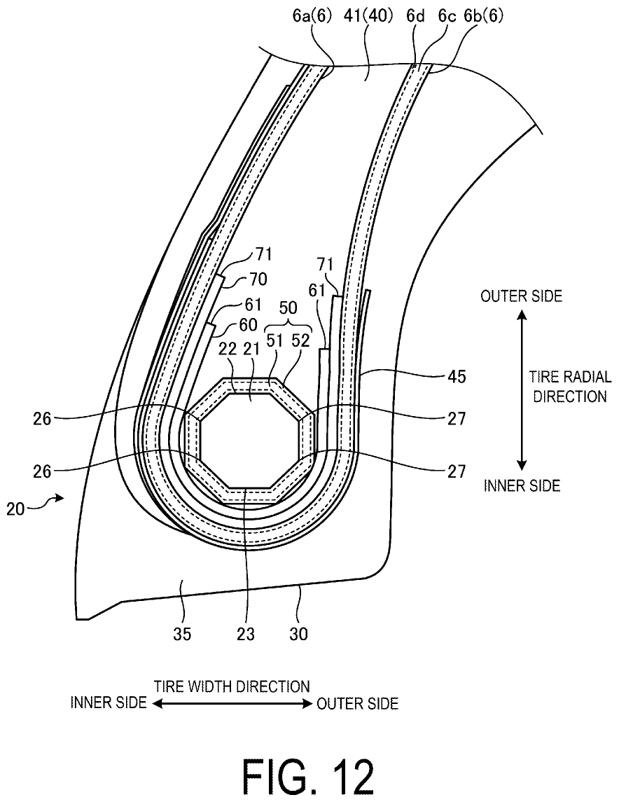

In the pneumatic tire 1 according to the first embodiment described above, the shape of the bead core 21 in the tire meridian cross-section is the substantially hexagonal cross-sectional shape, but the bead core 21 may be formed in a shape other than this. FIG. 12 is the modified example of the pneumatic tire 1 according to the first embodiment, and is an explanatory diagram in a case in which the cross-sectional shape of the bead core 21 is formed of an octagon. For example, as illustrated in FIG. 12, the bead core 21 of the pneumatic tire 1 according to the first embodiment may be formed to have a substantially octagonal cross-sectional shape in the tire meridian cross-section. In a case where the bead core 21 is formed in the substantially octagonal cross-sectional shape, when the innermost side in the tire width direction is formed along the tire radial direction, both of two corner portions located at both ends of the side are the bead core innermost points 26 of the bead core 21. Similarly, in a case where the bead core 21 is formed in the substantially octagonal cross-sectional shape, when the outermost side in the tire width direction is formed along the tire radial direction, both of two corner portions located at both ends of the side are the bead core outermost points 27 of the bead core 21.

Therefore, when the sides on both sides of the bead core 21 in the tire width direction are formed along the tire radial direction, the rubber reinforcing layer 60 of the pneumatic tire 1 according to the first embodiment is preferably disposed to cover a range over the sides on both sides of the bead core 21 in the tire width direction. Thus, the rubber reinforcing layer 60 can cover the two bead core innermost points 26 and the two bead core outermost points 27. Therefore, the rubber reinforcing layer 60 can more reliably alleviate the stress concentration in the portion where the stress is likely to concentrate between the bead core 21 formed in the substantially octagonal cross-sectional shape and the carcass 6. Therefore, a failure of the carcass 6 due to stress concentration can be suppressed, and the durability of the bead portion 20 can be improved.

Further, in the pneumatic tire 1 according to the second embodiment described above, the rubber reinforcing layer 60 is disposed over the entire circumference of the bead core 21 in the tire meridian cross-section, but the rubber reinforcing layer 60 need not be disposed over the entire circumference of the bead core 21.

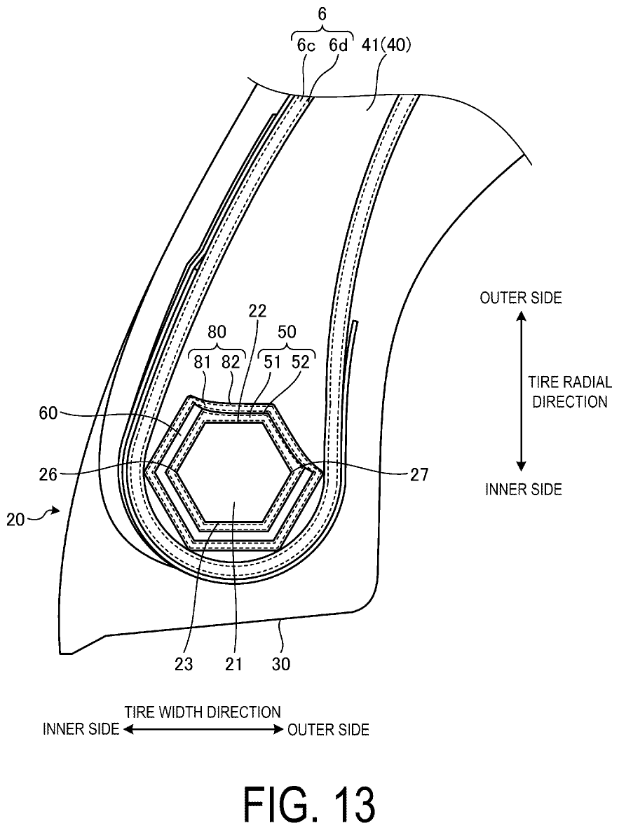

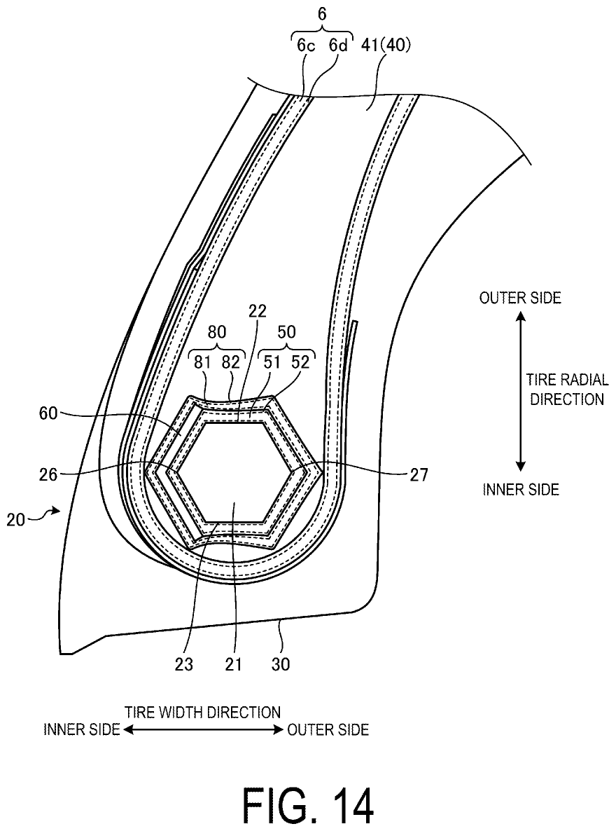

FIG. 13 is a modified example of the pneumatic tire 1 according to the second embodiment, and is an explanatory diagram of a state in which the rubber reinforcing layer 60 is disposed from the inner side of the bead core 21 in the tire width direction to the outer side in the tire width direction. FIG. 14 is a modified example of the pneumatic tire 1 according to the second embodiment, and is an explanatory diagram of a state in which the rubber reinforcing layer 60 is disposed on the inner side of the bead core 21 in the tire width direction. For example, as illustrated in FIG. 13, in the tire meridian cross-section, the rubber reinforcing layer 60 of the pneumatic tire 1 according to the second embodiment may be disposed to run through the inner side of the bead core 21 in the tire radial direction from the inner side of the bead core 21 in the tire width direction to the outer side of the bead core 21 in the tire width direction. In other words, the rubber reinforcing layer 60 may be disposed by folding back a sheet-like rubber member from the inner side of the bead core 21 in the tire width direction to the outer side of the bead core 21 in the tire width direction, not spirally winding the band-like rubber reinforcing material 65 (see FIG. 7) around the bead core 21. In this case, on the outer side of the inner organic fiber reinforced layer 50, a portion where the rubber reinforcing layer 60 is not disposed is in a state where the outer organic fiber reinforced layer 80 is directly disposed on the outer side of the inner organic fiber reinforced layer 50.

Alternatively, as illustrated in FIG. 14, the rubber reinforcing layer 60 of the pneumatic tire 1 according to the second embodiment may be disposed only in a portion on the inner side of the bead core 21 in the tire width direction. In this case as well, a sheet-like rubber member may be used as the rubber reinforcing layer 60, and the rubber reinforcing layer 60 may be disposed on the inner side of the bead core 21 in the tire width direction from a position further on the outer side in the tire radial direction than the outer circumferential surface 22 of the bead core 21 to a position further on the inner side in the tire radial direction than the bead core bottom 23. The rubber reinforcing layer 60 need not be disposed over the entire circumference of the bead core 21, and only needs to be disposed between the inner organic fiber reinforced layer 50 and the carcass 6 so as to cover at least the bead core innermost point 26.

Since the portion between the bead core innermost point 26 and the carcass 6 is a portion where stress concentration is likely to occur when a large tensile force acts on the carcass 6, the stress concentration can be suppressed by disposing the rubber reinforcing layer 60 so as to cover at least the bead core innermost point 26. As a result, wear of the coating rubber 6d due to the force acting between the carcass 6 and the bead core 21 can be suppressed, and a failure, such as break of the carcass cord 6c, can be suppressed. As a result, the durability of the bead portion 20 can be improved.

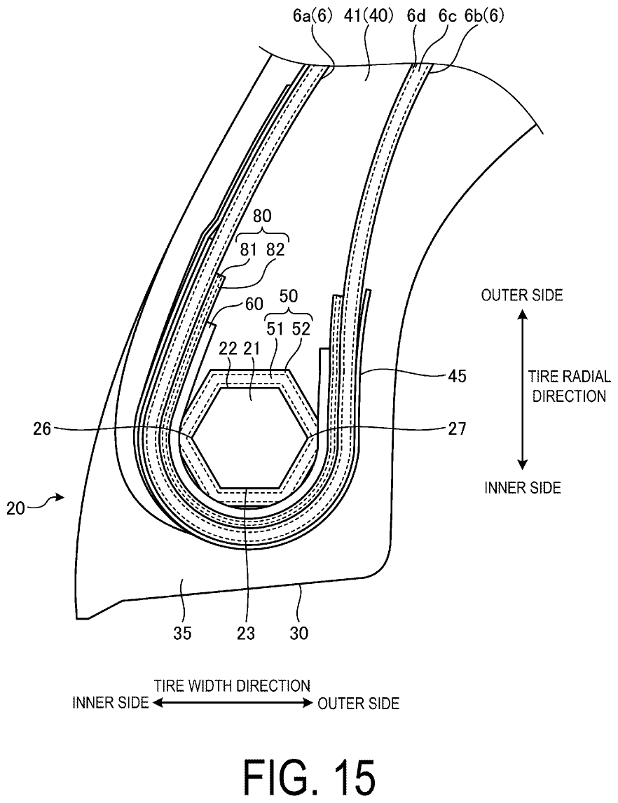

Further, in the pneumatic tire 1 according to the second embodiment described above, the outer organic fiber reinforced layer 80 is disposed over the entire circumference of the bead core 21 in the tire meridian cross-section, but the outer organic fiber reinforced layer 80 need not be disposed over the entire circumference of the bead core 21. FIG. 15 is a modified example of the pneumatic tire 1 according to the second embodiment, and is an explanatory diagram of a state in which the outer organic fiber reinforced layer 80 is disposed from the inner side of the bead core 21 in the tire width direction to the outer side in the tire width direction. For example, as illustrated in FIG. 15, in the tire meridian cross-section, the outer organic fiber reinforced layer 80 of the pneumatic tire 1 according to the second embodiment may be disposed to run through the inner side of the bead core 21 in the tire radial direction from the inner side of the bead core 21 in the tire width direction to the outer side of the bead core 21 in the tire width direction. In other words, as illustrated in FIG. 15, both the outer organic fiber reinforced layer 80 and the rubber reinforcing layer 60 may be disposed by folding back from the inner side of the bead core 21 in the tire width direction to the outer side of the bead core 21 in the tire width direction.

The outer organic fiber reinforced layer 80 only needs to be disposed at least between the rubber reinforcing layer 60 and the carcass 6, and run through the inner side of the bead core 21 in the tire radial direction from the inner side of the bead core 21 in the tire width direction to the outer side of the bead core 21 in the tire width direction. Since the outer organic fiber reinforced layer 80 is disposed between the rubber reinforcing layer 60 and the carcass 6, the outflow of the rubber reinforcing layer 60 from a position between the bead core 21 and the carcass 6 during vulcanization molding of the pneumatic tire 1 can be suppressed by the outer organic fiber reinforced layer 80. As a result, the force acting between the carcass 6 and the bead core 21 can be more reliably dispersed by the rubber reinforcing layer 60, and a failure, such as break of the carcass cord 6c, can be suppressed, and therefore the durability of the bead portion 20 can be improved.

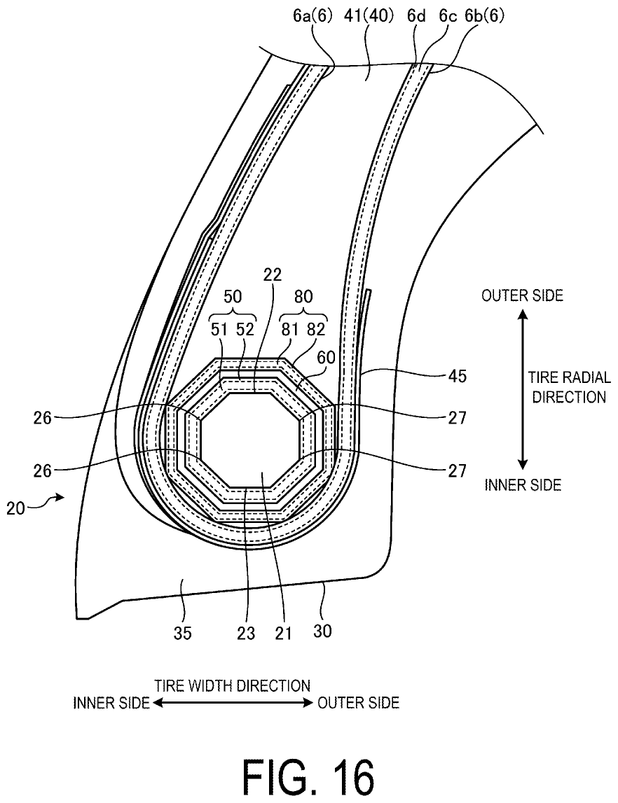

In the pneumatic tire 1 according to the second embodiment described above, the shape of the bead core 21 in the tire meridian cross-section is the substantially hexagonal cross-sectional shape, but the bead core 21 may be formed in a shape other than this. FIG. 16 is a modified example of the pneumatic tire 1 according to the second embodiment, and is an explanatory diagram in a case in which the cross-sectional shape of the bead core 21 is formed of an octagon. For example, as illustrated in FIG. 16, the bead core 21 of the pneumatic tire 1 according to the second embodiment also may be formed to have a substantially octagonal cross-sectional shape in the tire meridian cross-section, and the inner organic fiber reinforced layer 50, the rubber reinforcing layer 60, and the outer organic fiber reinforced layer 80 may be disposed to be wound around the bead core 21 having the substantially octagonal cross-sectional shape. In the pneumatic tire 1 according to the second embodiment as well, in a case where the bead core 21 is formed in the substantially octagonal cross-sectional shape, when the innermost side in the tire width direction is formed along the tire radial direction, both of two corner portions located at both ends of the side are the bead core innermost points 26 of the bead core 21.

Therefore, when the side on the innermost side of the bead core 21 in the tire width direction is formed along the tire radial direction, the rubber reinforcing layer 60 of the pneumatic tire 1 according to the second embodiment is preferably disposed to cover at least the two bead core innermost points 26. As a result, the rubber reinforcing layer 60 can more reliably alleviate the stress concentration in the portion where the stress is likely to concentrate between the bead core 21 formed in the substantially octagonal cross-sectional shape and the carcass 6. Therefore, a failure of the carcass 6 due to stress concentration can be suppressed, and the durability of the bead portion 20 can be improved.

Further, in the pneumatic tires 1 according to the first and second embodiments described above, one layer is disposed as the inner organic fiber reinforced layer 50, but the inner organic fiber reinforced layer 50 may be disposed by stacking a plurality of layers. Similarly, in the pneumatic tire 1 according to the second embodiment described above, one layer is disposed as the outer organic fiber reinforced layer 80, but the outer organic fiber reinforced layer 80 may be disposed by stacking a plurality of layers.

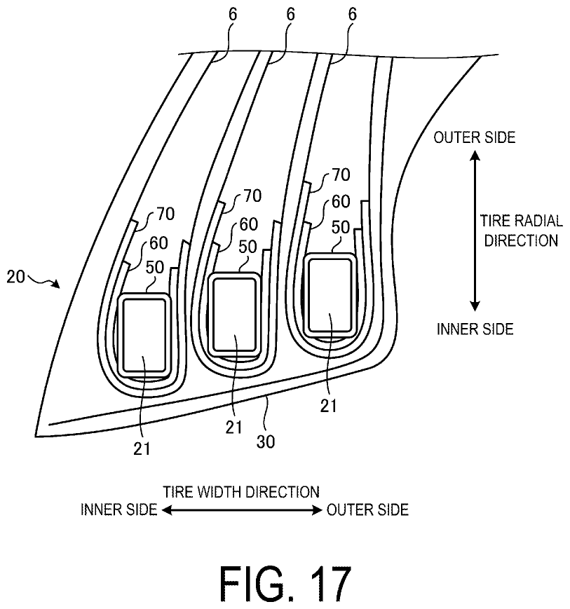

Further, in the pneumatic tire 1 according to the first embodiment described above, only one bead core 21 is disposed in one bead portion 20, but a plurality of the bead cores 21 may be disposed in one bead portion 20. FIG. 17 is the modified example of the pneumatic tire 1 according to the first embodiment, and is an explanatory diagram in a case where a plurality of the bead cores 21 are disposed in the bead portion 20. As illustrated in FIG. 17, for example, the three bead cores 21 of the pneumatic tire 1 according to the first embodiment may be disposed in one bead portion 20. In this case, the carcass 6 runs through the inner side of the bead core 21 in the tire radial direction from the inner side of the bead core 21 in the tire width direction and is folded back to the outer side in the tire width direction for each of the bead cores 21. In other words, the pneumatic tire 1 according to the first embodiment may be formed as a bias tire including the carcasses 6 including the cords of the bias plies. By stacking a plurality of the carcasses 6, the different carcasses 6 may be folded back for each of the bead cores 21 in the bead portion 20.

As described above, when the plurality of bead cores 21 are disposed in one bead portion 20 of the pneumatic tire 1 according to the first embodiment and the plurality of carcasses 6 are folded back for each of the bead cores 21, the inner organic fiber reinforced layer 50, the rubber reinforcing layer 60, and the rubber adhesive layer 70 are disposed for each of the bead cores 21. In other words, the inner organic fiber reinforced layer 50 may be wound around each of the plurality of bead cores 21 disposed in one bead portion 20, and the rubber reinforcing layer 60 and the rubber adhesive layer 70 may be disposed between each of the inner organic fiber reinforced layers 50 and each of the carcasses 6.

Even in a case where the plurality of bead cores 21 are disposed in one bead portion 20, when a large load acts on the pneumatic tire 1 and a large tensile force acts on the carcass 6, a failure of the carcass 6 due to rubbing between the carcass 6 and the bead core 21 possibly occurs in each of the carcasses 6. Therefore, when the plurality of bead cores 21 are disposed in one bead portion 20 and the plurality of carcasses 6 are folded back for each of the bead cores 21, the inner organic fiber reinforced layer 50, the rubber reinforcing layer 60, and the rubber adhesive layer 70 are also disposed for each of the bead cores 21, thereby allowing suppressing a failure of each of the carcasses 6. As a result, the durability of the bead portion 20 when the plurality of bead cores 21 are disposed in one bead portion 20 can be improved.

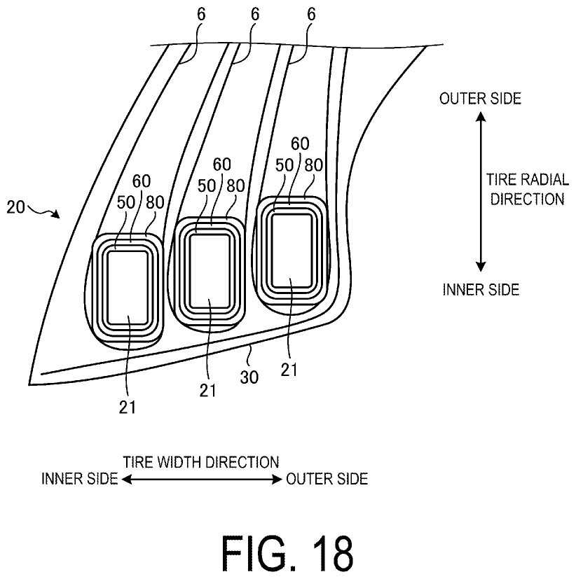

Similarly, also in the pneumatic tire 1 according to the second embodiment, a plurality of the bead cores 21 may be disposed in one bead portion 20. FIG. 18 is the modified example of the pneumatic tire 1 according to the second embodiment, and is an explanatory diagram in a case where a plurality of the bead cores 21 are disposed in the bead portion 20. Similarly, as illustrated in FIG. 18, for example, the three bead cores 21 of the pneumatic tire 1 according to the second embodiment may be disposed in one bead portion 20. In other words, similar in the second embodiment, the pneumatic tire 1 may be formed as a bias tire including the carcasses 6 including the cords of the bias plies. By stacking a plurality of the carcasses 6, the different carcasses 6 may be folded back for each of the bead cores 21 in the bead portion 20.

As described above, when the plurality of bead cores 21 are disposed in one head portion 20 of the pneumatic tire 1 according to the embodiment and the plurality of carcasses 6 are folded back for each of the bead cores 21, the inner organic fiber reinforced layer 50, the rubber reinforcing layer 60, and the second outer organic fiber reinforced layer 80 are disposed for each of the bead cores 21. Even in a case where the plurality of bead cores 21 are disposed in one bead portion 20, when a large load acts on the pneumatic tire 1 and a large tensile force acts on the carcass 6, a failure of the carcass 6 due to rubbing between the carcass 6 and the bead core 21 possibly occurs in each of the carcasses 6. Therefore, when the plurality of bead cores 21 are disposed in one bead portion 20 and the plurality of carcasses 6 are folded back for each of the bead cores 21, the inner organic fiber reinforced layer 50, the rubber reinforcing layer 60, and the outer organic fiber reinforced layer 80 are also disposed for each of the bead cores 21, thereby allowing suppressing a failure of each of the carcasses 6. As a result, the durability of the bead portion 20 when the plurality of bead cores 21 are disposed in one bead portion 20 can be improved.

### Examples

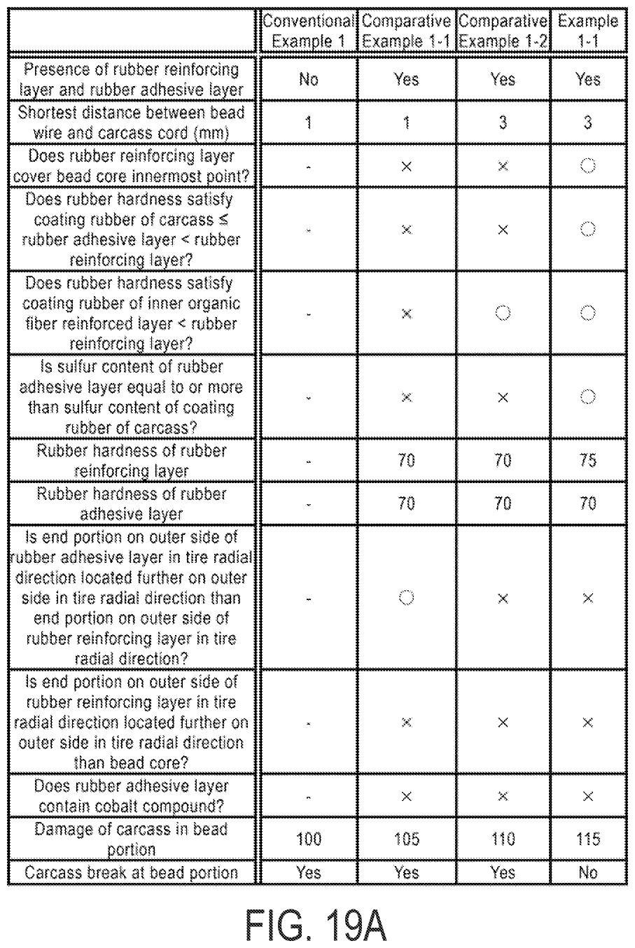

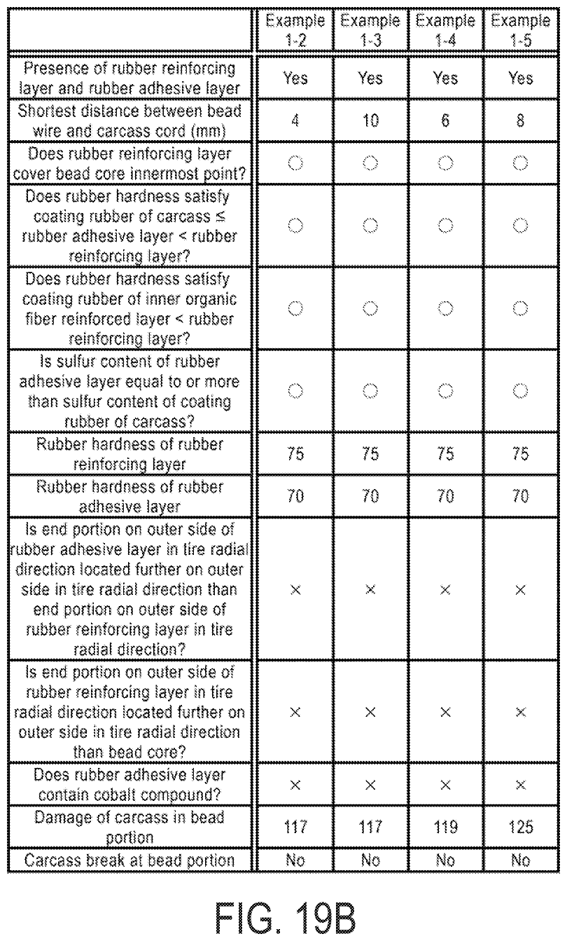

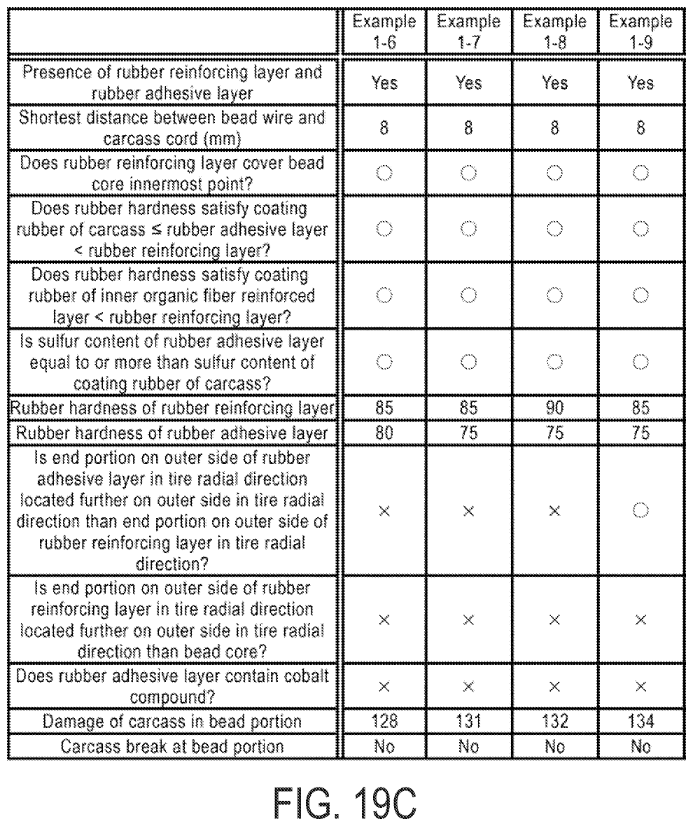

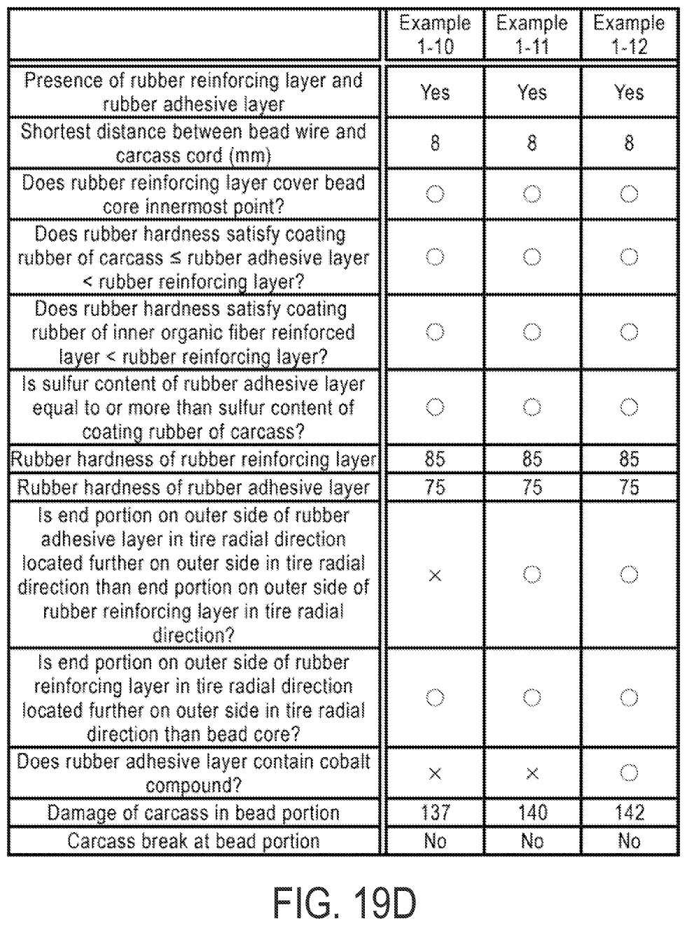

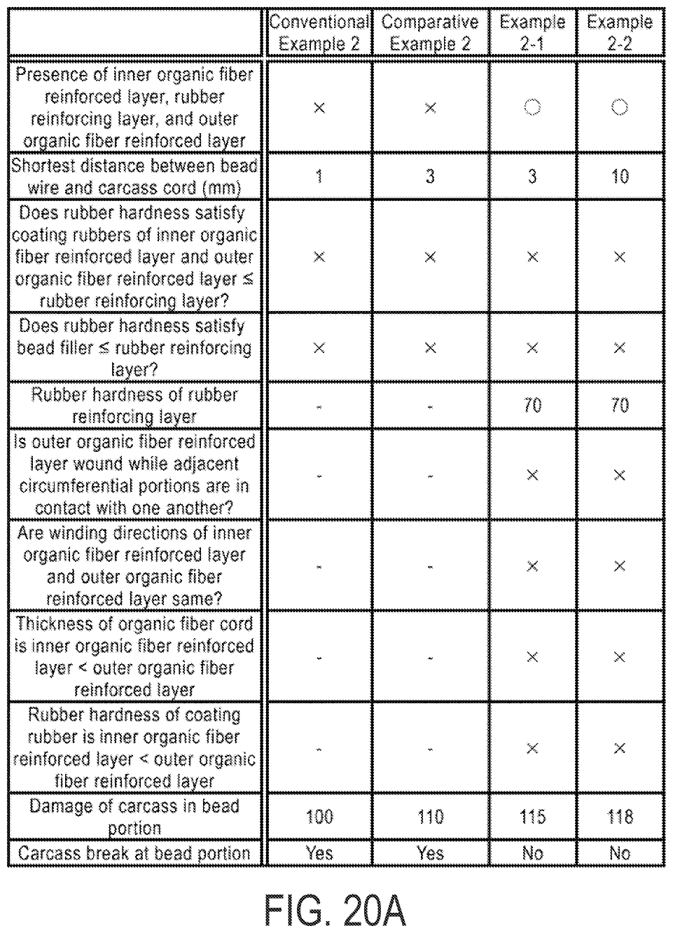

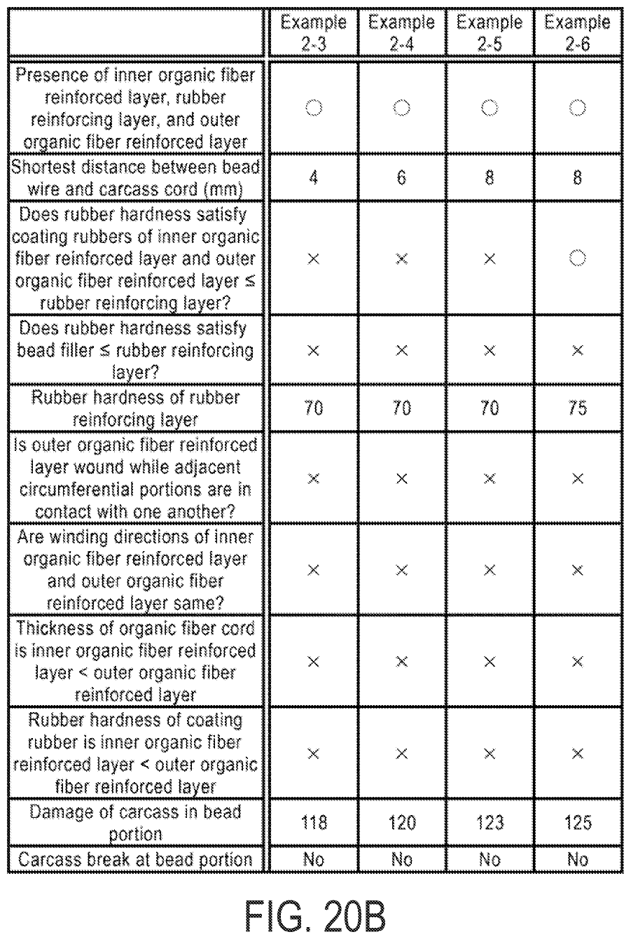

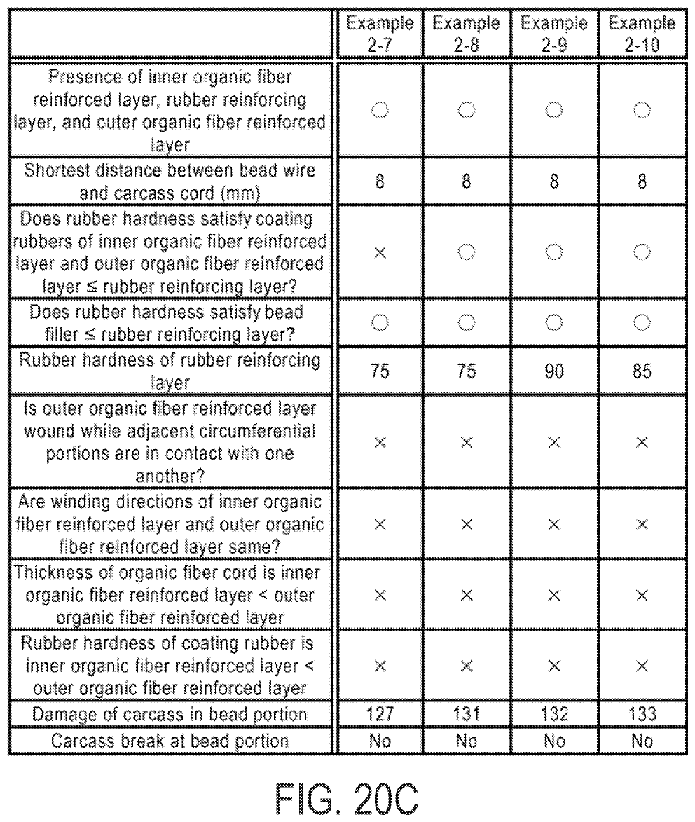

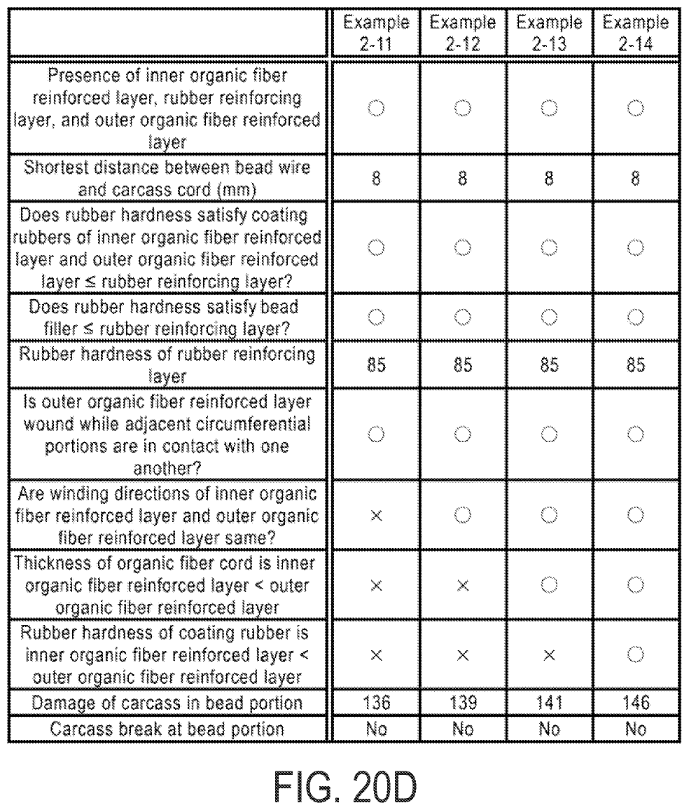

FIGS. 19A-19D include a table indicating results of a first performance evaluation test of pneumatic tires. FIGS. 20A-20D include a table indicating results of a second performance evaluation test of pneumatic tires. Hereinafter, in regard to the above-described pneumatic tire 1, the first and second performance evaluation tests performed on the pneumatic tires of Conventional Examples, the pneumatic tire 1 according to the embodiments of the present technology, and the pneumatic tires of Comparative Examples compared with the pneumatic tires 1 according to the embodiments of the present technology will be described. The first and second performance evaluation tests performed durability tests for evaluating the durability of the pneumatic tire 1,

In the first and second performance evaluation tests, the pneumatic tire 1 having a tire nominal of 46/90R57 size was used as a test tire. The test tire was mounted on a rim wheel conforming to the TRA standard, the air pressure was adjusted to an air pressure defined in the TRA standard, and the tests were performed with the tire subjected to a load specified by the TRA standard.

Among the evaluation items in the first and second performance evaluation tests, in the evaluation method of durability, using an indoor drum testing machine, a running test was performed with a load set to 85% of the maximum load specified by the TRA and a speed set to 15 km/h, after traveling of the pneumatic tire for 30 days set as a target running time, the durability test traveling was stopped, and evaluation was performed based on the degree of damage to the carcass in the head portion and the presence of break of the carcass cord in the bead portion. For presence of the break of the carcass cord in the bead portion, the carcass and the bead core were peeled in the bead portion of the pneumatic tire after the running test with the indoor drum testing machine, the degree of damage and break of the carcass cord were checked and the presence of a break of the carcass cord was checked. The degree of damage of the carcass in the bead portion, which indicates the durability of the bead portion, was evaluated by indexing the degree of damage and break of the carcass cord, and expressing the reciprocal of the index as an index with Conventional Example 1 described later as 100 in the first performance evaluation test and as an index with Conventional Example 2 described later as 100 in the second performance evaluation test.

The first performance evaluation test was performed on 15 types of pneumatic tires including a pneumatic tire of Conventional Example 1 corresponding to an example of a conventional pneumatic tire, Examples 1-1 to 1-12 corresponding to the pneumatic tires 1 according to the embodiments of the present technology, and Comparative Examples 1-1 and -2 corresponding to pneumatic tires to be compared with the pneumatic tires 1 according to the embodiments of the present technology. Among them, in the pneumatic tire of Conventional Example 1, although the inner organic fiber reinforced layer is wound around the bead core, the rubber reinforcing layer or the rubber adhesive layer is not disposed in the bead portion. In the pneumatic tire of Comparative Example 1-1, although the rubber reinforcing layer and the rubber adhesive layer are disposed in the head portion, the rubber hardness of the rubber reinforcing layer is not harder than the rubber hardness of the rubber adhesive layer or the rubber hardness of the coating rubber of the inner organic fiber reinforced layer, and the shortest distance between the bead wire and the carcass cord is not 3 mm or more. In the pneumatic tire of Comparative Example 1-2, although the rubber reinforcing layer and the rubber adhesive layer are disposed in the head portion, the rubber reinforcing layer does not cover the bead core innermost point.

On the other hand, in all of Examples 1-1 to 1-12, which are examples of the pneumatic tires 1 according to the embodiments of the present technology. the rubber reinforcing layers 60 are disposed in the bead portions 20, the rubber reinforcing layers 60 cover the bead core innermost points 26, and the shortest distances between the bead wires 28 and the carcass cords 6c are 3 mm or more. Furthermore, the respective pneumatic tires 1 according to Examples 1-1 to 1-12 differ in the rubber hardness of the rubber reinforcing layer 60, the rubber hardness of the rubber adhesive layer 70, whether the outer end portion 71 of the rubber adhesive layer 70 in the tire radial direction is located further on the outer side in the tire radial direction than the outer end portion 61 of the rubber reinforcing layer 60 in the tire radial direction, whether the outer end portion 61 of the rubber reinforcing layer 60 in the tire radial direction is located further on the outer side in the tire radial direction than the bead core 21, and whether the rubber adhesive layer 70 contains a cobalt compound.

As a result of the performance evaluation tests using the pneumatic tires 1, as illustrated in FIGS. 19A-19D, it is revealed that the pneumatic tires 1 according to Examples 1-1 to 1-12 have degrees of damage of the bead portions smaller than those of Conventional Example 1 and Comparative Examples 1-1 and 1-2, and breaks of the carcass cords 6c in the bead portions 20 are less likely to occur. The pneumatic tires 1 according to Examples 1-1 to 1-12 can provide improved durability of the bead portions 20.

The second performance evaluation test was performed on 16 kinds of pneumatic tires including a pneumatic tire of Conventional Example 2 corresponding an example of a conventional pneumatic tire, Examples 2-1 to 2-14 corresponding to the pneumatic tires 1 according to the embodiments of the present technology, and Comparative Example 2 corresponding to a pneumatic tire to be compared with the pneumatic tires 1 according to the embodiments of the present technology. Among them, in the pneumatic tire of Conventional Example 2, although the inner organic fiber reinforced layer is wound around the bead core, the rubber reinforcing layer or the outer organic fiber reinforced layer is not provided, and the shortest distance between the bead wire and the carcass cord is 1 mm. In the pneumatic tire of Comparative Example 2, although the inner organic fiber reinforced layer is wound around the bead core, the rubber reinforcing layer or the outer organic fiber reinforced layer is not provided, and the shortest distance between the head wire and the carcass cord is 3 mm.

In contrast, all of Examples 2-1 to 2-14, which are examples of the pneumatic tires 1 according to the embodiments of the present technology, include the inner organic fiber reinforced layers 50, the rubber reinforcing layers 60, and the outer organic fiber reinforced layers 80 in the bead portions 20. Further, the respective pneumatic tires 1 according to Examples 2-1 to 2-14 differ in the shortest distance between the bead wire 28 and the carcass cord 6c, whether the rubber hardness of the rubber reinforcing layer 60 is equal to or more than the rubber hardness of the coating rubber 52 of the inner organic fiber reinforced layer 50 or the rubber hardness of the coating rubber 72 of the outer organic fiber reinforced layer 80, whether the rubber hardness of the rubber reinforcing layer 60 is equal to or more than the rubber hardness of the bead filler 40, the rubber hardness of the rubber reinforcing layer 60, whether the outer organic fiber reinforced layers 80 are wound while the adjacent circumferential portions are in contact with one another, whether the directions of the inner organic fiber reinforced layer 50 and the outer organic fiber reinforced layer 80 being spirally wound are the same, whether the thickness of the organic fiber cord 81 of the outer organic fiber reinforced layer 80 is equal to or more than the thickness of the organic fiber cord 51 of the inner organic fiber reinforced layer 50, and whether the rubber hardness of the coating rubber 72 of the outer organic fiber reinforced layer 80 is equal to or more than the rubber hardness of the coating rubber 52 of the inner organic fiber reinforced layer 50.

As a result of the performance evaluation tests using the pneumatic tires 1, as illustrated in FIGS. 20A-20D, it is revealed that the pneumatic tires 1 according to Examples 2-1 to 2-14 have degrees of damage of the bead portions 20 smaller than those of Conventional Example 2 and Comparative Example 2, and also breaks of the carcass cords 6c in the bead portions 20 are less likely to occur. The pneumatic tires 1 according to Examples 2-1 to 2-14 can provide improved durability of the bead portions 20.

1-15. (canceled)

16. A pneumatic tire, comprising:
a pair of bead portions disposed on both sides of a tire equatorial plane in a tire width direction;
bead cores disposed in the bead portions, the bead cores being formed by winding bead wires in a ring shape and having a shape in a tire meridian cross-section formed in a polygonal cross-section; and
a carcass extended between the bead portions on both of the sides in the tire width direction, the carcass running through an inner side of the bead core in a tire radial direction from an inner side of the bead core in the tire width direction and being folded back to an outer side in the tire width direction in the bead portion, the carcass being formed by coating a carcass cord with a coating rubber;
an inner organic fiber reinforced layer wound around the bead core and formed by coating an organic fiber cord with a coating rubber; and
a rubber reinforcing layer disposed between the inner organic fiber reinforced layer and the carcass so as to cover at least an apex on an innermost side of the bead core in the tire width direction,
a shortest distance between the bead wire and the carcass cord being 3 mm or more.

17. The pneumatic tire according to claim 16, wherein
the rubber reinforcing layer is disposed to run through the inner side of the bead core in the tire radial direction from the inner side of the bead core in the tire width direction to an outer side of the bead core in the tire width direction,
a rubber adhesive layer is disposed between the rubber reinforcing layer and the carcass to run through the inner side of the bead core in the tire radial direction from the inner side of the bead core in the tire width direction to the outer side of the bead core in the tire width direction,
the rubber adhesive layer has a rubber hardness equal to or more than a rubber hardness of the coating rubber of the carcass,
the rubber reinforcing layer has a rubber hardness harder than a rubber hardness of the rubber adhesive layer and a rubber hardness of the coating rubber of the inner organic fiber reinforced layer, and
the rubber adhesive layer has a sulfur content equal to or more than a sulfur content of the coating rubber of the carcass.

18. The pneumatic tire according to claim 17, wherein
the rubber adhesive layer has a rubber hardness in a range of 72 or more and 78 or less.

19. The pneumatic tire according to claim 17, wherein
in portions located on the inner side of the bead core in the tire width direction of the rubber adhesive layer and the rubber reinforcing layer, an end portion on an outer side of the rubber adhesive layer in the tire radial direction is located further on the outer side in the tire radial direction than an end portion on the outer side of the rubber reinforcing layer in the tire radial direction.

20. The pneumatic tire according to claim 17, wherein
the rubber reinforcing layer has an end portion on an outer side in the tire radial direction located further on the outer side in the tire radial direction than an outer circumferential surface of the bead core.

21. The pneumatic tire according to claim 17, wherein
the rubber adhesive layer contains a cobalt compound.

22. The pneumatic tire according to claim 16, comprising
an outer organic fiber reinforced layer formed by coating an organic fiber cord with a coating rubber, the outer organic fiber reinforced layer being disposed at least between the rubber reinforcing layer and the carcass, the outer organic fiber reinforced layer being disposed to run through the inner side of the bead core in the tire radial direction from the inner side of the bead core in the tire width direction to an outer side of the bead core in the tire width direction.

23. The pneumatic tire according to claim 22, wherein
the rubber reinforcing layer has a rubber hardness equal to or more than rubber hardnesses of the coating rubber of the inner organic fiber reinforced layer and the coating rubber of the outer organic fiber reinforced layer.

24. The pneumatic tire according to claim 22, wherein
the organic fiber cord of the outer organic fiber reinforced layer has a thickness equal to or more than a thickness of the organic fiber cord of the inner organic fiber reinforced layer.

25. The pneumatic tire according to claim 22, wherein
the coating rubber of the outer organic fiber reinforced layer has a rubber hardness equal to or more than a rubber hardness of the coating rubber of the inner organic fiber reinforced layer.

26. The pneumatic tire according to claim 22, wherein
the outer organic fiber reinforced layer is formed by spirally winding a band-like member around the bead core extending in a tire circumferential direction, and
the band-like member is spirally wound while adjacent circumferential portions are in contact with one another.

27. The pneumatic tire according to claim 26, wherein
the inner organic fiber reinforced layer is formed by spirally winding a band-like member around the bead core extending in a tire circumferential direction, and
in the inner organic fiber reinforced layer and the outer organic fiber reinforced layer, a direction in which the band-like member forming the inner organic fiber reinforced layer is spirally wound is same as a direction in which the band-like member forming the outer organic fiber reinforced layer is spirally wound.

28. The pneumatic tire according to claim 16, wherein
the shortest distance between the bead wire and the carcass cord is in a range of 4 mm or more and 8 mm or less.

29. The pneumatic tire according to claim 16, wherein
the rubber reinforcing layer has a rubber hardness in a range of 80 or more and 85 or less.

30. The pneumatic tire according to claim 16, wherein
a bead filler is disposed on the inner side of a turned-up portion in the tire width direction and an outer side of the bead core in the tire radial direction, and the turned-up portion is a portion folded back to the outer side of the bead core in the tire width direction in the carcass, and
the rubber reinforcing layer has a rubber hardness equal to or more than a rubber hardness of the bead filler.
